(19) United States
(12) Patent Application Publication
(10) Pub. No.: US 2021/0342803 A1
(43) Pub. Date: Nov. 4, 2021

(54) METHOD AND APPARATUS FOR USING A SERVICE THROUGH BLOCKCHAIN SYSTEM

(71) Applicant: ELECTRONICS AND TELECOMMUNICATIONS RESEARCH INSTITUTE, Daejeon (KR)

(72) Inventor: Tae Whan Yoo, Daejeon (KR)

(21) Appl. No.: 17/177,576

(22) Filed: Feb. 17, 2021

(30) Foreign Application Priority Data
Feb. 17, 2020 (KR) 10-2020-0018844
Feb. 17, 2021 (KR) 10-2021-0021444

(51) Int. Cl. G06Q 20/14; G06Q 20/10; G06Q 20/38

(52) U.S. Cl. CPC G06Q 20/14; G06Q 20/102; G06Q 20/3829; G06Q 20/3827; G06Q 20/3825

(57) ABSTRACT

An apparatus and a method for using a service through a blockchain system to perform: confirming, through the blockchain system by using the communication device, that a provider node providing the service is a participant in a decentralized network; and using the service provided by the provider node when it is confirmed through the blockchain system by using the communication device that the provider node is the participant of the decentralized network are provided.

### CROSS-REFERENCE TO RELATED APPLICATIONS

This application claims priority to and the benefit of Korean Patent Application No. 10-2020-0018844 filed in the Korean Intellectual Property Office on Feb. 17, 2020, and Korean Patent Application No. 10-2021-0021444 filed in the Korean Intellectual Property Office on Feb. 17, 2021, the entire contents of which are incorporated herein by reference.

### BACKGROUND OF THE INVENTION

### 1. Field of the Invention

This description relates to a method and an apparatus for using a service through a blockchain system.

### 2. Description of Related Art

Communication networks are generally a centralized operation system provided by communication providers. Even after an IP network designed to operate based on a distribution protocol is introduced, the communication networks are operated by the communication provider as an AS (Autonomous System) unit defined by the expansion limit of the distribution protocol. Since telephone networks do not need to be controlled by a service session unit, the role of the communication service provider has been reduced to a network resource provider that provides a physical or logical connection path. On the other hand, since mobile communications are a network service that continuously controls the service session according to the moving of the subscriber station, it is operated in the centrally controlled manner by the communication provider.

The 5G network, which has been recently introduced in mobile communication, has been expanded in terms of scale and performance, such as large capacity, low latency, and the large number of terminals, and the network structure of the 5G network is fundamentally changing to enable these characteristics of the 5G network.

In the 5G network, a network service control function is implemented by a combination of small software modules (Network Function, NF) operating as a service-based interface (Service based Interface, SBI). At this time, the NF is completely separated from network resources and can be displayed in various positions in a variety of sizes and shapes. Because the network services can be realized through microservices, containers, automatic install operations, and so on developed for the cloud, the network resources and the network services will be more clearly separated, and accordingly, network resource provisioning and network service provisioning can be defined as independent business areas.

As the network resources and the network services are separated, various types of 5G networks are expected to emerge, and to cope with the new 5G networks, a standard for accepting a private (non-public) 5G network has been included in 3GPP Release 16. In order to implement large capacity, a micro cell base station needs to be densely deployed in private land or public areas such as campus, streets, factories, buildings, companies, indoors, and at this time, it can be difficult for a single operator to exclusively own and operate all network resources as before. Since the need to share the network resources has increased, as an example, schemes for sharing radio resources and base stations between mobile communication providers such as an open-radio access network (ORAN) association are being discussed.

In the network field, methods of using a blockchain as a means of sharing or decentralization are proposed and implemented. A telecommunication service provider may use the blockchain to improve the existing service, or a new telecommunication service provider may employ the blockchain to provide a service differentiated from the existing telecommunication service provider. The former telecommunication service provider may perform direct transactions between communication providers through the blockchain without a clearing house, and share information about the subscriber with other telecommunication providers, so that the same level of service as the subscriber roaming between the providers can be provided to the subscriber without the clearing house. The latter telecommunication service provider can realize new services such as roaming service, rich communication service, shared WiFi, and so on by sharing the subscriber information with other telecommunication service providers and calculating costs using the blockchain.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An embodiment provides an apparatus for using a service through a blockchain system.

Another embodiment provides a method for using a service through a blockchain system.

Yet another embodiment provides a blockchain system.

According to an embodiment, an apparatus for using a service through a blockchain system is provided. The apparatus includes: a processor, a memory, and a communication device, wherein the processor executes a program stored in the memory to perform: confirming, through the blockchain system by using the communication device, that a provider node providing the service is a participant in a decentralized network; and using the service provided by the provider node when it is confirmed through the blockchain system by using the communication device that the provider node is the participant of the decentralized network.

The processor may execute the program to further perform paying a charge for the use of the service through the blockchain system by using the communication device after the using of the service.

When the processor performs the paying of the charge for the use of the service through the blockchain system, the processor may perform: receiving billing details of the charge and proof of service provision from the provider node by using the communication device; verifying the billing details by using the proof of service provision; and transmitting a service smart contract transaction to pay the charge through the blockchain system by using the communication device when the billing details are verified.

The processor may execute the program to further perform: connecting with a bootstrapping server of the decentralized network by using the communication device and installing a participant decentralizing functional module under a control of the bootstrapping server; and generating a blockchain account by using the participant decentralizing functional module and registering a user node coupled to the apparatus in the blockchain system through a registration smart contract module of the blockchain system. When the service is a network service provided using a network resource, the user node may be a terminal and the provider node may be a network service provider.

When the service is a service that provides a network resource, the user node may be a network service provider that provides the service using the network resource, and the provider node may be a resource provider.

The processor may execute the program to further perform: selecting a service that the provider node is capable of providing within a provider portal of the provider node; and generating a subscriber account for the user node in the provider node and setting a deposit for the service.

The processor may execute the program to further perform: receiving an identifier of the provider node and a service specification of the service selected by the provider node from the provider node through a user portal by using the communication device, wherein when the processor performs the confirming, through the blockchain system by using the communication device, that a provider node providing the service is a participant in the decentralized network, the processor may perform confirming, by using the identifier of the provider node, that the provider node is a registered participant in the decentralized network.

Before the processor performs the using the service provided by the provider node, the processor may execute the program to further perform: agreeing on a master symmetric key with the provider node; and generating an encryption key from the master symmetric key and encrypting a channel required for the service using generated encryption key.

According to another embodiment, a method for using a service through a blockchain system is provided. The method includes: confirming, through the blockchain system, that a provider node providing the service is a participant in a decentralized network; and using the service provided by the provider node when it is confirmed through the blockchain system that the provider node is the participant in the decentralized network.

The method may further include: after the using of the service, paying a charge for the use of the service through the blockchain system.

The paying of the charge for the use of the service through the blockchain system may include: receiving billing details of the charge and proof of service provision from the provider node; verifying the billing details by using the proof of service provision; and transmitting a service smart contract transaction to pay the charge through the blockchain system when the billing details are verified.

The method may further include: connecting with a bootstrapping server of the decentralized network and installing a participant decentralizing functional module under a control of the bootstrapping server; and generating a blockchain account by using the participant decentralizing functional module and registering a user node in the blockchain system through a registration smart contract module of the blockchain system.

When the service is a network service provided using network resources, the user node may be a terminal and the provider node may be a network service provider.

When the service is a service that provides a network resource, the user node may be a network service provider that provides the service using the network resource, and the provider node may be a resource provider.

The method may further include: selecting a service that the provider node is capable of providing within a provider portal of the provider node; and generating a subscriber account for the user node in the provider node and setting a deposit for the service.

The method may further include receiving an identifier of the provider node and a service specification of the service selected by the provider node from the provider node through a user portal, wherein the confirming, through the blockchain system, that a provider node providing the service is a participant in the decentralized network may include confirming, by using the identifier of the provider node, that the provider node is a registered participant in the decentralized network.

The method may further include: before the using of the service provided by the provider node, agreeing on a master symmetric key with the provider node; and generating an encryption key from the master symmetric key and encrypting a channel required for the service using generated encryption key.

According to yet another embodiment, a blockchain system is provided. The blockchain system includes: a registration smart contract module configured to register a participant in the decentralized network by processing a registration-related transaction generated by the participant; a service smart contract module configured to process a transaction generated when the participant uses the decentralized network to provide a service or the participant uses the decentralized network to use the service; and a blockchain database configured to process cryptocurrency assets used when the participant uses the service or provides the service, wherein the participant is one of a user node that uses the service, a provider node that provides the service or provides the resource for the service.

### BRIEF DESCRIPTION OF THE DRAWINGS

FIG. 1 is a block diagram illustrating a decentralized network according to an embodiment.

FIG. 2 is a schematic diagram illustrating a method of providing a network service by a plurality of network service providers through a decentralized network according to an embodiment.

FIG. 3 is a block diagram illustrating a blockchain system of a decentralized network according to an embodiment.

FIG. 4 is a block diagram illustrating a decentralizing functional unit of a decentralized network according to an embodiment.

FIG. 5 is a block diagram illustrating a decentralizing functional unit of the decentralized network according to another embodiment.

FIG. 6 is a block diagram illustrating a participant decentralizing functional module of the decentralizing functional unit according to an embodiment.

FIG. 7 is a schematic diagram illustrating an operation of the bootstrapping server of the decentralizing functional unit according to an embodiment.

FIG. 8 is a flowchart illustrating an operation of the decentralized network according to an embodiment.

FIG. 9A is a flowchart illustrating a method for registering a participant node by a participant decentralizing functional module according to an embodiment.

FIG. 9B is a flowchart illustrating a method for releasing the registration of the participant mode by the participant decentralizing functional module according to an embodiment.

FIG. 9C is a flowchart illustrating a method for releasing the registration of the participant node by the participant decentralizing functional module according to another embodiment.

FIG. 10 is a flowchart illustrating a method for managing a subscription of a participant decentralizing functional module according to an embodiment.

FIG. 11 is a flowchart illustrating a method for subscription management of a participant decentralizing functional module according to another embodiment.

FIG. 12 is a flowchart illustrating mutual authentication, key agreement, and an authorization method of the participant decentralizing functional module in a service use process according to an embodiment.

FIG. 13 is a flowchart illustrating mutual authentication, key agreement, and an authorization method of the participant decentralizing functional module according to another embodiment.

FIG. 14 is a flowchart illustrating mutual authentication, key agreement, and an authorization method of the participant decentralizing functional module according to another embodiment.

FIG. 15 is a flowchart illustrating charging, billing, and payment method of a participant decentralizing functional module according to an embodiment.

FIG. 16 is a schematic diagram illustrating the charging, billing, and payment method of the participant decentralizing functional module according to an embodiment.

FIG. 17 is a flowchart illustrating an automatic payment method of the participant decentralizing functional module according to an embodiment.

FIG. 18 is a flowchart illustrating the direct charging method of the participant decentralizing functional module according to an embodiment.

FIG. 19 is a flowchart illustrating the charging, billing, and payment method of the participant decentralizing functional module according to another embodiment.

FIG. 20 is a schematic diagram illustrating the charging, billing, and payment method of the participant decentralizing functional module according to another embodiment.

FIG. 21 is a flowchart illustrating a charging trigger and service proof method according to an embodiment.

FIG. 22 is a flowchart illustrating the charging, billing, and payment method of the participant decentralizing functional module according to another embodiment.

FIG. 23 is a flowchart illustrating the operation of the provider node of the decentralized network according to the embodiment.

FIG. 24 is a flowchart illustrating the process of the user node in the decentralized network according to an embodiment.

FIG. 25 is a block diagram illustrating a blockchain system according to another embodiment.

### DETAILED DESCRIPTION OF THE EMBODIMENTS

In the following detailed description, only certain embodiments of the present disclosure have been shown and described in detail with reference to the accompanying drawing, simply by way of illustration. However, the present disclosure may be implemented in various different forms and is not limited to the embodiments described herein. Further, in order to clearly describe the description in the drawing, parts not related to the description are omitted, and similar reference numerals are attached to similar parts throughout the specification.

Throughout the specification, a node may be called user equipment (UE), a terminal, a mobile station (MS), a mobile terminal (MT), an advanced mobile station (AMS), a high reliability mobile station (HR-MS), a subscriber station (SS), a portable subscriber station (PSS), an access terminal (AT), a machine type communication device (MTC device), and the like and may also include all or some of the functions of the MS, the MT, the AMS, the HR-MS, the SS, the PSS, the AT, the UE, the MTCH device, and the like.

In this specification, unless explicitly described to the contrary, the word “comprises”, and variations such as “including” or “containing”, will be understood to imply the inclusion of stated elements but not the exclusion of any other elements.

In this specification, expressions described in singular can be interpreted as singular or plural unless explicit expressions such as “one” or “single” are used.

In this specification, “and/or” includes all combinations of each and at least one of the mentioned elements.

In this specification, terms including ordinal numbers such as first and second may be used to describe various configurations elements, but the elements are not limited by the terms. The terms may be only used to distinguish one element from another element. For example, a first element may be named a second element without departing from the right range of the present disclosure, and similarly, a second element may be named a first element.

In the flowchart described with reference to the drawings in this specification, the order of the operations may be changed, several operations may be merged, certain operations may be divided, and specific operations may not be performed.

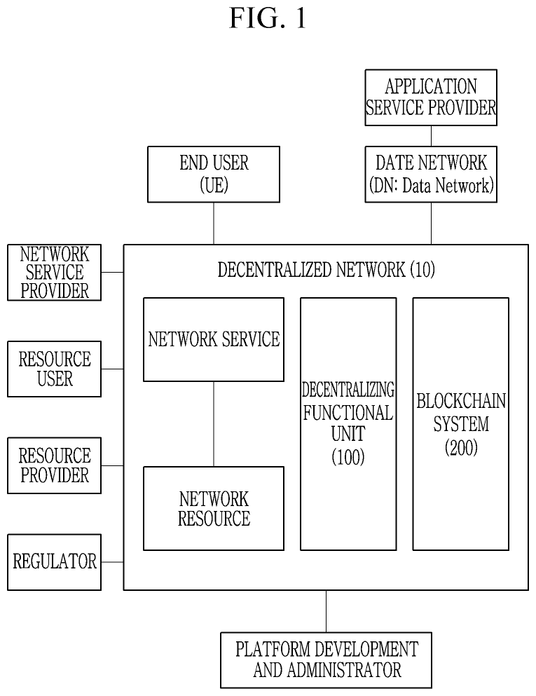

FIG. 1 is a block diagram illustrating a decentralized network according to an embodiment.

Network service providers and/or telecommunication providers may provide network services to users by using network resources of the decentralized network 10 according to the embodiment. Here, telecommunication service providers, the network resource providers, and network service providers may all be participants of the decentralized network 10 realized with the blockchain system.

Participants of the decentralized network 10 according to the embodiment may include resource providers, resource users, network service providers, end users (UE, etc.), platform development and administrator, and the like. Single participant may participate in the decentralized network 10 in multiple participant's roles. For example, the network service provider 20 may participate as a user role using the network resources, and may also play a role of a network service provider providing the network services using the network resources. The network resource user may perform a role of a network provider by configuring and providing higher-level network resources by utilizing resources provided by the resource provider. There should be at least one participant in each participant role in the decentralized network 10.

The network resources may include physical resources and virtual resources needed to provide the network services. For example, the network resources may include wireless frequencies, base stations, fixed wireless access networks (WiFi, etc.), wired access networks, switches, routers, transmission systems, transmission links, virtualization functions, computing resources, storages, and so on.

The network service may include a mobile communication network service implemented by software. Here, the mobile communication network service (such as 5G network service) may be implemented by software, so that efficient decentralization can be realized. The functions of the network services may include the control plane function and the user plane function of the network services, and may include a dynamic operation management function of the control plane function and the user plane function. A business support system (BSS) and an operation support system (OSS) may be included in the functions of the network service provider.

The network resources and the network services may include network resources and network services that are already existing or to be realized in the future. The network resources and the network services are functionally differentiated from the decentralization functionality. Since the network resources and the network services are provided by a plurality of participants in the decentralized network 10 according to the embodiment, the provisioning and use of the network resources, and the provisioning and use of the network services may be made through transactions between the participants.

Referring to FIG. 1, the decentralized network 10 according to the embodiment may include a decentralizing functional unit 100 and a blockchain system 200.

The decentralizing functional unit 100 may include a plurality of function modules for implementing the decentralized network. The transactions between the participants providing the network resources and network services may be realized by the decentralizing functional unit 100.

The blockchain system 200 may mediate the provisioning of services and the use of services among the participants. For example, the blockchain system 200 may process transactions between the participants related to the provisioning and the use of the services, and may process and store cryptocurrency assets for provisioning and use of the services. The transactions between the participants providing the network resources and the network services may be validated and logged through the blockchain system 200, so that the trust of the transactions may be guaranteed.

According to the embodiment, functions related to the decentralization may be realized by the decentralizing functional unit 100 and the blockchain system 200, and the provisioning and use of the network resources and the network services may be performed independently of decentralization. Therefore, the network services and the network resources may be evolved independently of the decentralizing functional unit 100 and the blockchain system 200 according to the embodiment. In addition, by adding the decentralizing function to network functions and terminals in a conventional mobile communication network, the decentralization may be realized without changing the existing functions.

Referring to FIG. 1, the decentralized network 10 according to the embodiment may be connected with a regulator and an application service provider.

The regulator may monitor whether public assets such as wireless frequencies are being used fairly in accordance with contracts with the central or local governments, and if there are problems, they may restrict the use of the public assets.

In order to provide a network service required for an application service, the 5G network may provide an application service provider data paths with QoS controlled by the unit of each application service flow. For example, the application service provider may define an application function (AF) in the 5G network, and the application service provider may dynamically control the 5G network service through a network exposure function (NEF) using the AF. An application service provider according to the embodiment may play a role differentiated from the previously described participant of the decentralized network 10, where the application service provider may be defined as an independent role of the participant. A data network (DN) which provides a connection between the application service provider and the decentralized network 10 a network in which the application service is provided and may include the Internet, the telephone network, and the like.

The decentralized network 10 according to the embodiment may also be connected with platform development and administrator. The platform development and administrator may be in charge of the development, operation management, and evolution of the decentralized network 10. In other words, the platform development and administrator may play a role of developing, installing, operating, and improving each function module included in the decentralizing functional unit 100. Rewards for the platform development and administration and other expenses may be covered by funds accumulated from all transactions of the decentralized network 10. At least one participant may participate as the platform development and administrator, and each participant may be connected to the independent decentralizing functional unit 100. Participants who play the role of platform development and administrator may participate as members of an decentralized autonomous organization (DAO) and expose the activities of development and administration as open sources. In this way, even if only one participant participates as the platform development and administrator, the monopoly of the decentralized network system can be prevented.

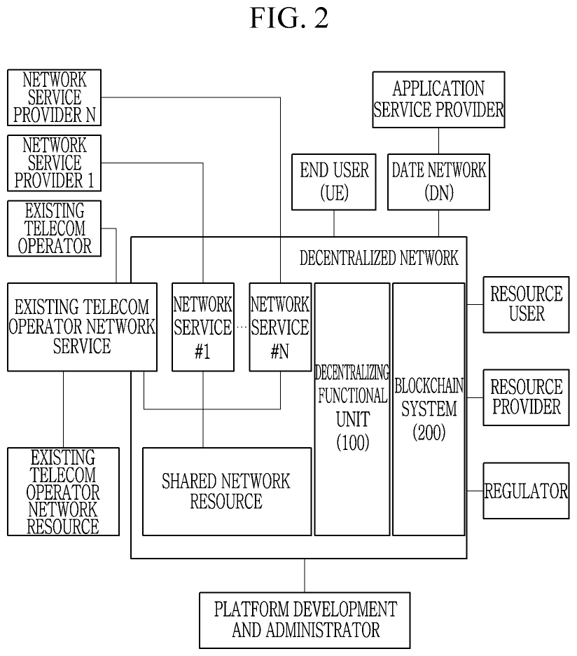

FIG. 2 is a diagram illustrating a method of providing a network service by a plurality of network service providers through a decentralized network according to an embodiment.

Referring to FIG. 2, a plurality of network service providers may provide a plurality of network services by using network resources of the decentralized network 10. The plurality of network service providers may also include existing communications providers. The communications providers may provide existing network services in the area of the decentralized network 10 by using their own network resources and simultaneously using shared network resources of the decentralized network 10. That is, an end user 10 subscribed to the existing communication service provider may also use the network services of the existing communication service provider in the area of the decentralized network 10. When the end user 10 subscribes to a network of the existing communication service provider by using an identifier of the decentralized network 10, the end user 10 may pay a service charge through a blockchain. When the end user 10 does not subscribe to the network of the existing communication service provider, the end user 10 may use the network service of the existing communication service provider by considering the network service of the existing communication service provider as a roaming-type visited network service.

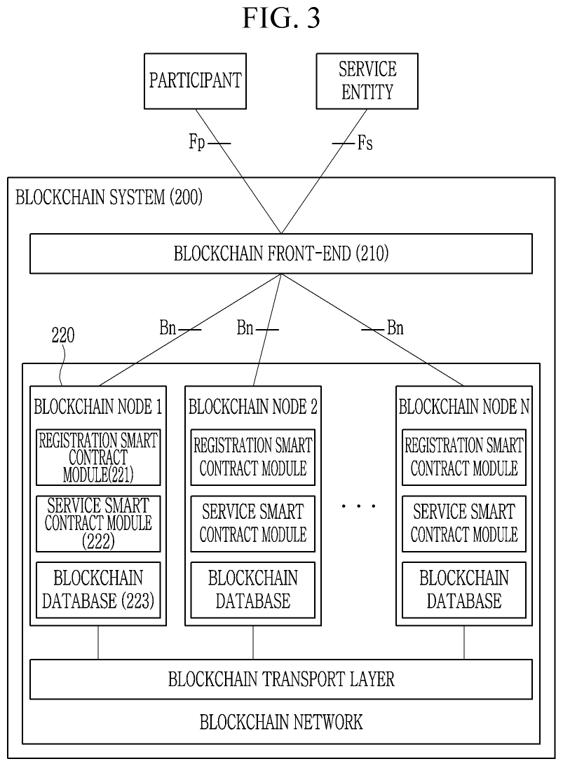

FIG. 3 is a block diagram illustrating a blockchain system of a decentralized network according to an embodiment.

A blockchain system 200 according to the embodiment may include a blockchain front-end 210 and a plurality of blockchain node 220. The plurality of blockchain node 220 and the blockchain front-end 210 may be connected through a Bn interface.

The blockchain front-end 210 may provide a blockchain function to participants through an Fp interface, or provide the blockchain function to service entities through an Fs interface. The blockchain front-end 210 may be collocated within a blockchain node 220 or may be installed independently as shown in FIG. 3. The Bn interface may be implemented by using a protocol between internal processes when the blockchain front-end 210 is collocated within the blockchain node 220, and when installed outside of the blockchain node 220, it may be implemented by using a protocol between remote processes or an HTTP.

A blockchain network that includes the plurality of blockchain nodes 220 and a blockchain transport layer between the blockchain nodes may be implemented by using a non-permission type blockchain such as Ethereum or a permission type blockchain such as Hyperledger. In the decentralized network 10 according to the embodiment, a type of the blockchain network may not be specifically specified. When IoT network services are provided through the decentralized network 10, more frequent service transactions are expected than the current Internet, and accordingly, the service transactions need to be confirmed in a short time. Therefore, the type of the blockchain network needs to meet the requirements of the decentralized network 10 on the throughput and the confirmation time of transactions.

Each of the blockchain node 220 may include a registration smart contract module 221, a service smart contract module 222, and a blockchain database 223.

The registration smart contract module 221 may register a participant of the decentralized network 10 according to the participant's role and manage registration status of the participant. For example, the registration smart contract module 221 may register participants in the decentralized network 10 by defining their activities and making a deposit relevant to each participant's role, so that the participants who do not have mutual trust can authenticate each other. The registration smart contract module 221 according to the embodiment may register participants in the decentralized network 10, manage registration information, and perform authentication for the registered participants by using a method that all participants on the blockchain can validate. In addition, when a participant performs malicious actions that threaten the reliability of the decentralized network 10, the registration smart contract module 221 may deregister the participant and confiscate the deposit according to the conditions regulated in the registration smart contract module 221.

The service smart contract module 222 may execute transactions according to contracts between participants, including the provisioning and the use of the resources between registered participants, provisioning and use of the network services, and the like, and may guarantee the reliability of the transactions. Variables of the service smart contract module 222 may be determined by transaction pattern between the participants, and the service smart contract module 222 according to the embodiment may present transaction patterns.

The blockchain front-end 210 may provide services of the blockchain network to the participants and the service entities through the blockchain interfaces such as Fp interface and Fs interface. For example, the blockchain front-end 210 may provide the blockchain interfaces Fp and Fs to the service entity 50 and a blockchain wallet of the participant, respectively, and may deliver the services related to service requests received through the blockchain interface by connecting to at least one blockchain node 220. In addition, the blockchain front-end 210 may transmit the processing result of the service request to the blockchain wallet of the participant or the service entity 50. To this end, the front-end 210 of the blockchain may perform functions such as transfer and creation of the transactions, interworking with the smart contract modules, and search and extraction of data of the blockchain.

For example, the blockchain front-end 210 may transmit the transaction received through the blockchain interfaces Fp and Fs to the blockchain node 220, or may transmit create transactions according to the transaction request received through the blockchain interface and transmit the created transactions to the blockchain node 220, or may detect a completion of the transaction and notify the corresponding blockchain wallet or the service entity of the completion of the transaction. The blockchain front-end 210 may receive and process a service request for a smart contract through the blockchain interface, and may notify the participant or the service entity of the processing result for the service request. Alternatively, the blockchain front-end 210 may search for the status and storage records in the blockchain according to requests received through the blockchain interface, and transmit data extracted from the searched result to the participant or the service entity.

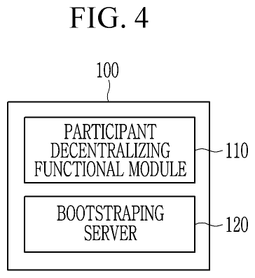

FIG. 4 is a block diagram illustrating a decentralizing functional unit of a decentralized network according to an embodiment.

Referring to FIG. 4, a decentralizing functional unit 100 according to the embodiment may include a participant decentralizing functional module 110 and a bootstrapping server 120. The participant decentralizing functional module 110 may be installed in a participant node 20 (or participant terminal) by the bootstrapping server 120. The participant node 20 may participate in the blockchain system 200 in the decentralized network 10 via participant decentralizing functional module 110 installed by the bootstrapping server 120 of the decentralizing functional unit 100.

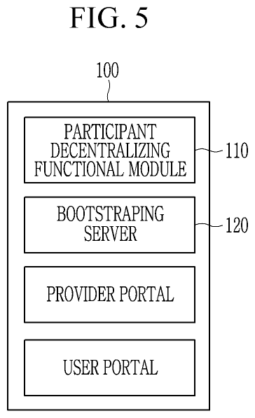

FIG. 5 is a block diagram illustrating a decentralizing functional unit of the decentralized network according to another embodiment.

Referring to FIG. 5, a decentralizing functional unit 100 according to another embodiment may further include a portal function related to the participant, such as a provider portal and a user portal. The portal function may be installed as a network service of the decentralized network 10, or may be included in the participant decentralizing functional module 110 when the participant decentralizing functional module 110 is installed in the participant node by the bootstrapping server 120.

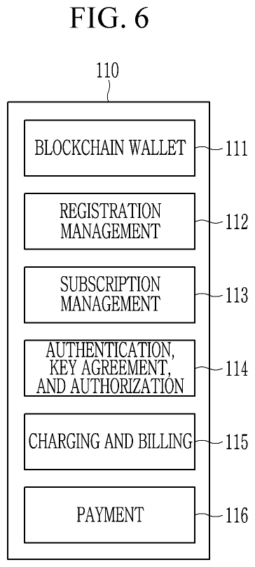

FIG. 6 is a block diagram illustrating a participant decentralizing functional module of the decentralizing functional unit according to an embodiment.

Referring to FIG. 6, the participant decentralizing functional module 110 according to the embodiment may perform functions such as blockchain wallet 111, registration management 112, subscription management 113, authentication, key agreement, and authorization 114, charging and billing 115, and payment 116.

The participant node 20 may access the blockchain network using the blockchain wallet function 111 of the participant decentralizing functional module 110, create a blockchain account, manage the created account, issues blockchain transactions, and check the status of nodes of the blockchain network. Depending on the type of the blockchain network employed in the decentralized network 10, a corresponding blockchain wallet may be configured for the participant node.

The registration management 112 may be a function for registering participants with the role of each participant. The participant node 20 may be registered in the blockchain network by sending a participant registration transaction to the registration smart contract module 221 using the registration management function 112 of the participant decentralizing functional module 110. Through the registration management function 112, an identifier that uniquely identifies the participant node 20 in the decentralized network 10 may be created, and the created identifier may be registered in the blockchain system 200 as the identifier of the participant node 20. In addition, the participant node 20 may make a deposit corresponding to the participant role using the registration management function 112 of the participant decentralizing functional module 110 when issuing the registration transaction to the registration smart contract module 221. The deposit corresponding to the participant role may be both to entrust the participant node with its role and to prevent attacks such as the Sybil Attack, which paralyzes the registration function by indiscriminate participant registration.

The participant node 20 may subscribe itself as a counterparty to a transaction management function of another participant node through the subscription management function 113 of the participant decentralizing functional module 110. One participant node may perform transactions between participant nodes after joining as the counterparty of another participant node's transaction. The other participant may manage the subscriber account for the participant node subscribed as the counterparty. Subscriber account management may include functions for creating a subscriber account, storing information (including a participant's identifier) and subscription profile of the subscribed participant, and updating the stored information with the latest information. The participant node 20 may perform a transaction based on the information stored in the subscriber account when the transaction occurs with a participant who subscribes as the counterparty.

The participant node 20 may perform mutual authentication of transaction participants (e.g., service providers and service users) through the authentication, key agreement, and authorization function 114 of the participant decentralizing functional module 110, agree on an encryption key used for encryption of a service message channel and a service provision between participants, and grant permission to the user of the service. The service provider may include the resource provider or the network service provider, and the service user may include the resource user, the final user 10, or the application service provider.

The service may include providing network resources, or providing network services. The participant decentralizing functional module 110 may distinguish between a subscribed participant and a non-subscribed participant by the subscription management functions including the authentication, key agreement, and authorization function 114.

The participant node 20 may perform a charging function that calculates the charge for the service used by the user through the charging and billing function 115 of the participant decentralizing functional module 110 and a billing function that bills the user for the charge calculated by the charging function. The charging and billing function 115 of the participant decentralizing functional module 110 according to the embodiment may include a charging and billing method by a provider as in the case of the existing telecommunication service provider and a charging and billing method by a service entity.

The participant node 20 may use the payment function 116 of the participant decentralizing functional module 110 to pay the fee charged to the user by the charging and billing function. The payment function 116 of the participant decentralizing functional module 110 according to the embodiment may include an automatic payment function and a manual payment function. The automatic payment function is a function to verify the details of the fees charged through proof of service provision and to automatically pay the verified charges with assets stored in the blockchain account. The manual payment function may inform the service consumer(user) of the billing details when the bill is issued. The payment function 116 may be performed through the service smart contract module 222 of the blockchain node 220.

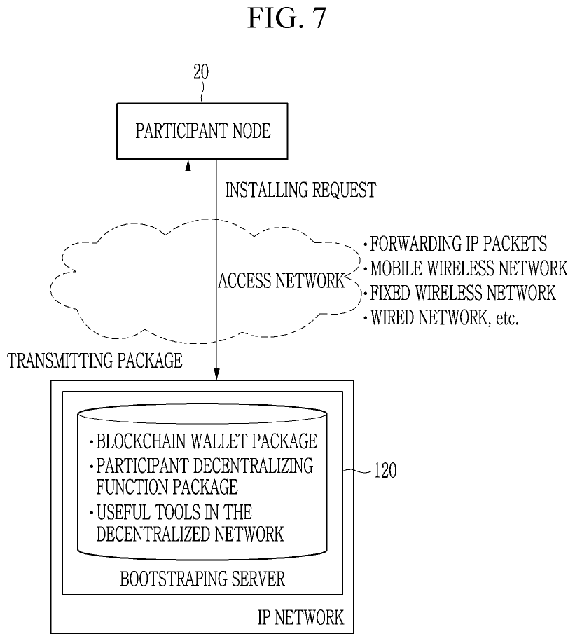

FIG. 7 is a diagram illustrating an operation of the bootstrapping server of the decentralizing functional unit according to an embodiment.

The bootstrapping server 120 of the decentralizing functional unit 100 may install the participant decentralizing functional module 110 of the decentralizing functional unit 100 to the terminal or node of the participant. In addition, the bootstrapping server 120 may update the version of the participant decentralizing functional module 110 to the latest. Here, the participant node 20 may mean each entity participating in the blockchain system 200, and may include an end user, a network service provider, a resource user, a resource provider, a regulator, an application service provider, a platform development and administrator, and so on.

1. Referring to FIG. 7, the participant node 20 may access the bootstrapping server 120 in the IP network through an access network through which IP packets are transferred. The access network may include a 3GPP mobile wireless network, a WiFi fixed wireless network, a wired access network, or a network service provided by the decentralized network according to the embodiment. The participant node 20 accessed to the bootstrapping server 120 in the IP network may request a software package such as the blockchain wallet package and the decentralized function package corresponding to the participant role to the bootstrapping server 120. The bootstrapping server 120 may provide a web page in which the software package required for each participant role is displayed to the participant node 20 so that participant node 20 can select the software package.

2. The bootstrapping server 120 may send the software package requested by the participant node 20 to the participant node 20.

3. The participant node 20 may execute the participant decentralizing functional module 110 by installing the software package received from bootstrapping server 120.

4. The bootstrapping server 120 may check the version of the installed software package when the participant node 20 accesses to the decentralized network 10, and indicate the participant node 20 to update the software if necessary. The participant node 20 may download and install useful tools from the decentralized network 10 through the bootstrapping server 120. Installation, update, and deletion of the useful tools may be performed as needed.

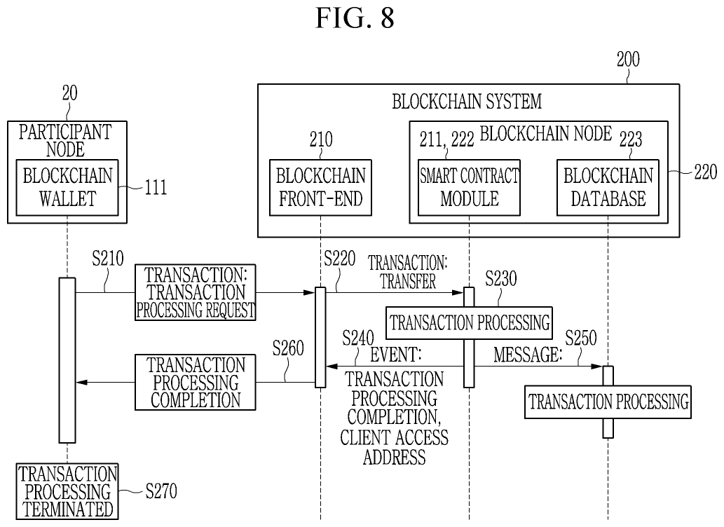

FIG. 8 is a flowchart illustrating an operation sequence of the decentralized network according to an embodiment.

1. Referring to FIG. 8, the participant decentralizing functional module 110 of participant node 20 may send a transaction processing request including the created transaction to the blockchain system 200 of the decentralized network 10 by executing the transaction creation process through the blockchain wallet function 111 (S210). The transaction created by the participant node 20 may be propagated to the plurality of blockchain nodes 220 in the blockchain system 200.

2. The transaction is transferred to the blockchain front-end 210 through the blockchain interface, and the blockchain front-end 210 may propagate the transaction to the plurality of blockchain nodes 220 (S220).

3. The smart contract modules 221 and 222 of each blockchain node 220 may process the requested transaction (S230), and generate process completion event (S240). If the transaction requires the exchange of the cryptocurrency asset, the smart contract modules 221 and 222 may transmit a message related to the processing of the cryptocurrency asset to the blockchain database 223 (S250).

4. When the process completion event is detected, the blockchain front-end 210 may transmit the transaction completion message to the blockchain wallet 111 function of the participant node 20 (S260).

5. The blockchain wallet function 111 may terminate the transaction process upon receiving the transaction completion message from the blockchain front-end 210 (S270).

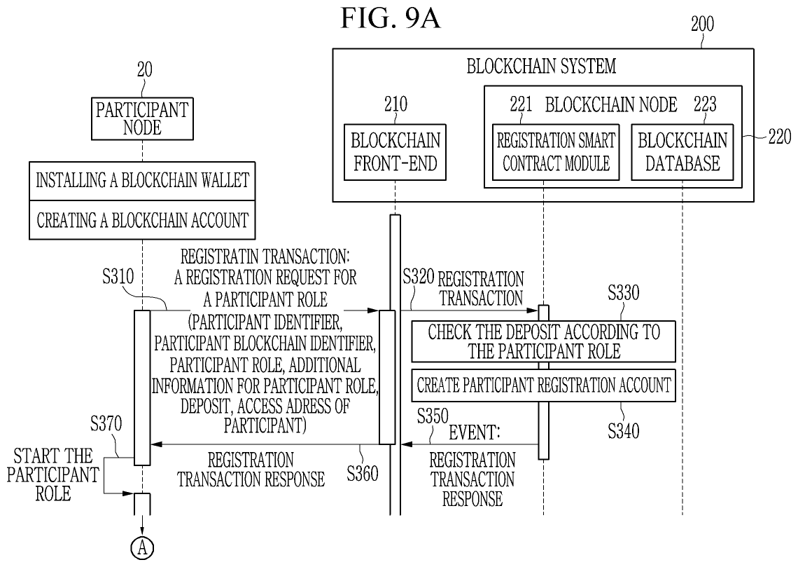

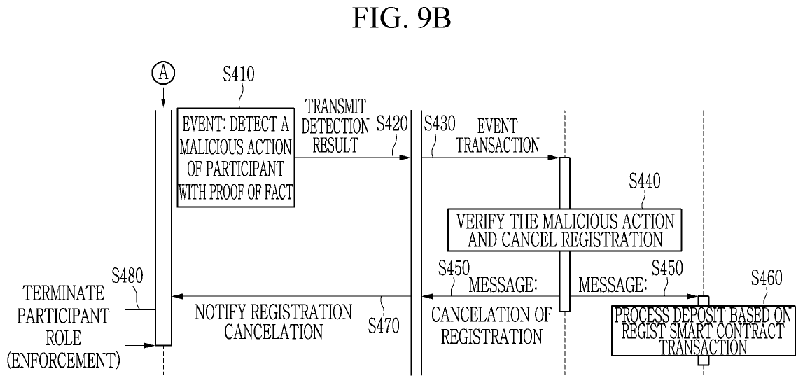

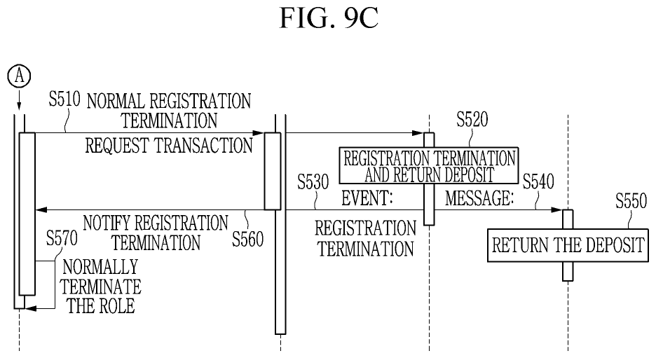

FIG. 9A is a flowchart illustrating a method for registration sequence of a participant node by the participant decentralizing functional module according to an embodiment, FIG. 9B is a flowchart illustrating a method for deregistering participant mode by the participant decentralizing functional module according to an embodiment, and FIG. 9C is a flowchart illustrating a normal deregistration sequence of a participant node by the participant decentralizing functional module according to another embodiment.

1. Referring to FIG. 9A, the participant node 20 may install a downloaded blockchain wallet function 111 through the bootstrapping server 120, and may use the blockchain wallet function 111 to create a blockchain account.

2. The participant node 20 may determine a participant role by initiating a registration process, and may send a registration transaction including a participant identifier for identification of the participant node 20 in the decentralized network 10 to the blockchain system 200 of the decentralized network 10 (S310). The registration transaction may further include a blockchain account identifier of the participant, the participant role, a deposit required for the participant role, a public key of the participant, an access address of the participant, and so on.

3. The blockchain front-end 210 of the blockchain system 200 may transfer the registration transaction to the plurality of blockchain nodes 210 (S320).

4. When the blockchain node 220 receives the registration transaction from a transaction pool, the blockchain node 220 may check the deposit corresponding to the participant role by executing the registration smart contract module 221 (S330). When it is confirmed that the deposit is appropriate, the blockchain node 220 may create a participant registration account through the registration smart contract module 221 (S340). Data including the blockchain account identifier, the participant role, additional information for the participant role, the deposit, the public key of the participant, and so on may be stored for each participant identifier in the participant registration account.

The participant node 20 may update related information in the participant registration account when the information of the participant node 20 is changed. When the participant node 20 performs the role of the end user, the participant registration account may further include information on the network service provider subscribed by using the participant information.

5. When a registration transaction completion event is detected (S360), the blockchain front-end 210 may transmit a registration transaction completion message to the participant node 20 (S350).

6. The participant node 20 may start the participant role when it is confirmed that the registration transaction has been successfully processed according to the registration transaction completion message (S370), and the participant node 20 may terminate the registration process when it is confirmed that the registration transaction is not successfully processed.

Below, Referring to FIG. 9B, the abnormal termination process of the participant role is described.

1. Referring to FIG. 9B, when a participant node 20 participated in the blockchain system 200 with a participant role commits an action that threatens the reliability of the decentralized network 10 (e.g., malicious behavior), monitoring tools or other participant node may detect the behavior of the participant node 20 (S410) and transfer information on the detected behavior to the blockchain front-end 210 (S420).

2. The blockchain front-end 210 may notify the event of the malicious behavior (S430). Here, the transaction may include information about the behavior detected by the monitoring tools or other participant node.

3. The registration smart contract module 221 may verify the malicious behavior based on the information about the detected behavior included in the transaction issued by the blockchain front-end 210 (S440). When the registration smart contract module 221 determines that the detected behavior is a malicious action, the registration smart contract module 221 may send a registration cancellation message to the participant node 20 who committed the malicious action, trigger a registration cancellation procedure, and send a deposit processing message to the blockchain database 223 (S450).

4. The blockchain database 223 may process the deposit according to the deposit processing message generated by the registration smart contract module 221 (S460).

5. When the blockchain front-end 210 detects a registration cancellation event, the blockchain front-end 210 may notify the participant node 20 of the registration cancellation (S470).

6. When the participant node 20 receives the registration cancellation message, the participant node 20 may terminate the participation as the participant role (S480).

The process of normal termination of participant role is described in detail below referring to FIG. 9C.

1. Referring to FIG. 9C, the participant node 20 participating in a participant role may transmit a deregistration transaction for the participant role to the blockchain front-end 210 (S510).

2. Afterwards, the blockchain front-end 210 may transmit the deregistration transaction to the blockchain node 220.

3. After receiving the deregistration transaction, the registration smart contract module 221 of the blockchain node 220 may terminate the registration status of the participant node 20 (S520), and generate a deregistration event (S530). The registration smart contract module 221 may send a deposit return message to the blockchain database 223 to return the deposit to the participant node 20 (S540).

4. The blockchain database 223 can return the deposit to the participant node 20 when the deposit return message is received from the registration smart contract module 221 S550.

5. The blockchain front-end 210 may transfer a deregistration message to the participant node 20 when the deregistration event is detected (S560).

6. When the participant node 20 receives the deregistration message, the participant node 20 may normally terminate the process of the participant role (S570).

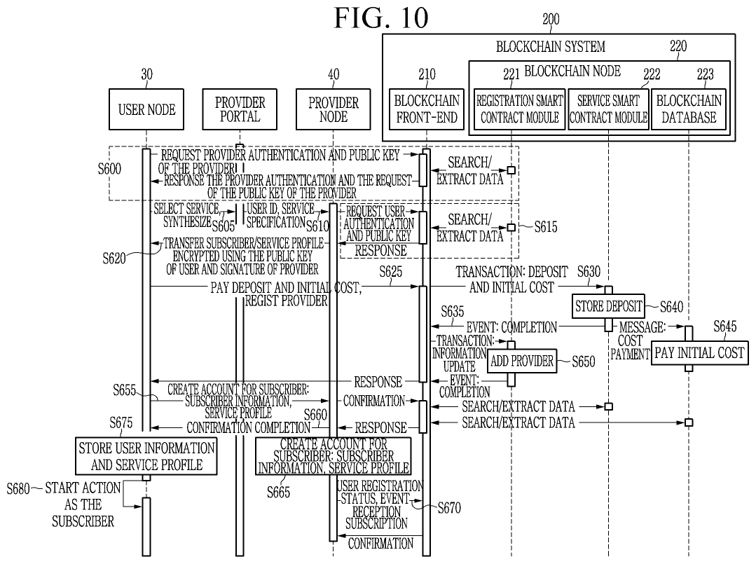

FIG. 10 is a flowchart illustrating the procedure to manage the subscription using a participant decentralizing functional module according to an embodiment.

The participant node 20 may subscribe to an account provided by another participant node through the subscription management function 113 of the participant decentralizing functional module 110 to execute trustworthy transactions with the other participant node to maintain the subscription status, and terminate the mutual transaction. For example, an end user may subscribe to the account of the provider of a network service through the subscription management function 113 in order to use the network service. Alternatively, a network service provider may subscribe to the account of the provider of a network resource in order to use the network resource. FIG. 10 shows the subscription management procedure that a user subscribes to the account of a service provider.

Referring to FIG. 10, a user node 30 which initiates the subscription process may confirm through the registration smart contract module 221 of the blockchain system 200 that the participant node (referred as a ‘provider node’ in FIG. 10) that provides the account to subscribe is a normal participant in the decentralized network 10 (S600). Specifically, the participant decentralizing functional module 110 of the user node 30 may request authentication of the provider node 40 and the public key of the provider node 40 to the blockchain system 200. The blockchain front-end 210 may transfer the request message for the authentication of the provider node 40 and the public key of the provider node 40 from the user node 30 to the registration smart contract module 221. The registration smart contract module 221 may inquire a participant registration account based on an identifier of the provider node 40 included in the authentication request and transfer an authentication result and the public key of the provider node 40 to the user node 30 via the blockchain front-end 210 when the authentication of the provider node 40 is successful. The public key of the provider delivered to the user node 30 may be used for mutual authentication. For example, when the provider node 40 transfers a signature encrypted by the private key of the provider node, the user node 30 may verify that the encrypted signature is of the provider node 40 by using the public key of the provider node 40. In addition, since the user node 30 may encrypt service access data by using the encryption key of the provider node 40 when the user node 30 accesses a service, only the provider node 40 intended by the user node 30 may check the service access data. When the identifier of the user node is confirmed, the user node 30 and the provider node 40 may encrypt messages related to the network service by using the preset symmetric key.

1. The user node 30 may determine a service through a provider portal of the provider node 40 (S605).

2. The provider node 40 may receive the profile of the service selected by the user node 30 and the identifier of the user node through the provider portal (S610). After that, the provider node 40 may verify that the user node 30 is a participant registered in the decentralized network 10 through the blockchain system 200 by using the identifier of the user node 30 (S615). Thereafter, when it is verified that the user node 30 is a user of the decentralized network 10, the provider node 40 may receive the public key of the user node 30 from the registration smart contract module 221.

3. The provider node 40 may manage the user node 30 in a subscriber account created by the provider node 40 for the user node 30. The information about the subscriber account may include information of the subscriber and the service profiles selected by the user node 30. The information of the subscriber may include a user identifier, a subscriber identifier, a master symmetric key to be shared with the subscriber, and the public key of the user node. Thereafter, the provider node may encrypt the information about the subscriber and the service profile with the public key of the user node 30 and attach the signature of the provider node 40 to the encrypted subscriber information and service specifications to transmit the encrypted subscriber information and service specifications to the user node 30 (S620).

4. The user node 30 may transmit service smart contract transaction and registration smart contract transaction to the blockchain system 200 (S625). The service smart contract transaction transmitted to the blockchain system 200 by the user node 30 may be to make a deposit required for the initial installation of the service, to request the service, and to pay the fee for the service. The registration smart contract transaction may be to add the provider node 40 to participant registration account information of the user node 30.

5. The blockchain front-end 210 may transfer the received service smart contract transaction and the registration smart contract transaction to the blockchain node 220 (S630). Then, the service smart contract transaction and the registration smart contract transaction may be processed by the service smart contract module and the registration smart contract module in the blockchain node 220. The service smart contract module and the registration smart contract module may generate events after processing the transactions (S635). When transaction processing events are detected, the blockchain front-end 210 may notify the user node 30 that the processing of the transaction has been completed.

The service smart contract module 222 may store the deposit when processing the service smart contract transactions (S640) and allow the blockchain database 230 to pay the initial cost (S645). The registration smart contract module 221 may add the identifier of the provider node 40 to registration participant specification of the participant registration account of the user node 30 (S650).

6. The user node 30 may notify the provider node 40 that the deposit and the initial installation fee have been paid (S655).

7. The provider node 40 may confirm that the deposit and the initial installation fee have been paid by the user node 30 through the blockchain system 200, and notify the user node 30 that the confirmation of the payment of the deposit and the initial installation fee has been completed (S660).

The provider node 40 may manage the subscriber information and the service profile for the user node 30 by creating the subscriber account for the user node 30 (S665). The provider node 40 subscribes to the participant registration status event notification service of the user through the blockchain front-end 210, so that information in the subscriber account can be updated when the participant registration status of the user node 30 is changed (S670).

8. The user node 30 may store the subscriber information and the service profile transferred by the provider node 40 (S675) and use the service of the provider node 40 (S680).

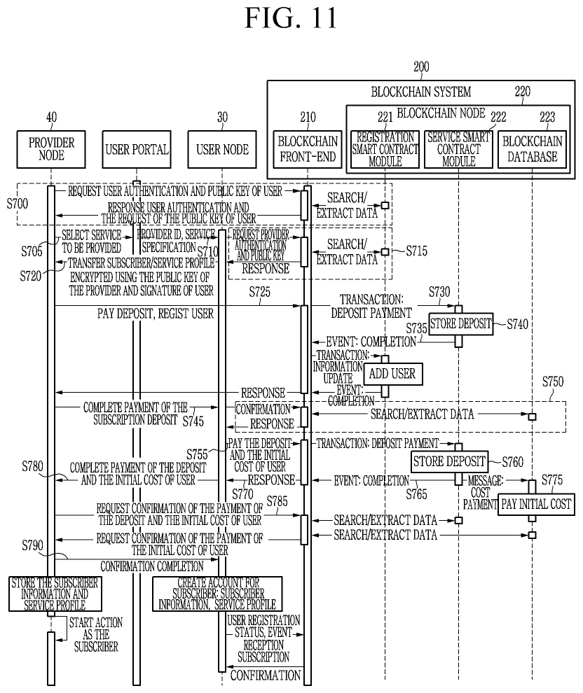

FIG. 11 is a flowchart illustrating for the procedure to manage the service subscription by a participant decentralizing functional module according to another embodiment.

FIG. 11 shows a subscription management procedure that can occur in a user-led transaction relationship. The network service provider may be the user node 30 in terms of using network resources, and the network service provider as the user node 30 may announce network resource requirements through the user portal and invite provider nodes for the network resource. The provider node 40 for the network resource may present the network resources that can be provided through the user portal, and may subscribe to the account of the user node 30 to provide the network resources to the user node 30. Thereafter, the user node 30 may provide the network service using the network resources provided by the subscribed provider node 40.

1. Referring to FIG. 11, the provider node 40 may initiate the subscription process by authenticating the user node 30 that wants to subscribe to the account through the blockchain system 200 (S700). Specifically, the provider node 40 may confirm by using the registration smart contract module 221 in the blockchain system 200 that the user node 30 is a normal participant in the decentralized network 10. When the user node is authenticated by the registration smart contract module 221, the registration smart contract module 221 may read the public key of the user node 30 from the participant registration account of the user node 30 in the participant registration information stored in the blockchain database 223.

2. The provider node 40 may select services that can be provided through the user portal of the user node 30 (S705).

3. The user node 30 may receive the identifier of the provider node 40 and the service profile selected by the provider node 40 through the user portal (S710). Then, the user node 30 may confirm by using the identifier of the provider node 40 that the provider node 40 is a registered participant in the decentralized network 10, and may receive the public key of the provider node 40 through the blockchain system 200 (S715).

4. The user node 30 may manage the provider node 40 in the subscriber account of the user node 30 by creating subscriber account information of provider node 40. The subscriber account information may include subscriber information and service specifications of the service selected by the provider node 40. The subscriber information may include a provider identifier, a subscriber identifier, a master symmetric key to be shared with the subscriber, a public key of the provider, and the like.

In addition, the user node 30 may encrypt the subscriber information and the service profile with the public key of the provider node 40, and attach a signature of the user node 30 to the subscriber information and the service specification encrypted by using the public key to transmit the subscriber information and the service specification to the provider node 40 (S720).

5. The provider node 40 may send the service smart contract transaction and the registration smart contract transaction to the blockchain system 200 (S725). The service smart contract transaction may be for payment of the deposit required mutually during the service provision process. The registration smart contract transaction may be to add the user node 30 to the subscription participant specification of the participant registration account information of the provider node 40.

6. The blockchain front-end 210 may transfer two type of transactions (the service smart contract transaction and the registration smart contract transaction) to the blockchain node 220 (S730). The two transactions transferred to the blockchain node 220 may be processed by the registration smart contract module 221 and the service smart contract module 222, respectively. The blockchain front-end 210, which has detected all events occurring after each of the two transactions is processed, may notify the provider node 40 of the processing completion of the transactions (S735). When the service smart contract module 222 processes the transaction, it may complete the receipt of the deposit (S740). When the registration smart contract module 221 processes the transaction, it may add the identifier of the user node 30 to the participant registration account information of the provider node 40.

7. Then, the provider node 40 may notify the user node 30 of the completion of the deposit placement (S745).

8. The user node 30 may confirm that the deposit has been made through the blockchain system 200 (S750). The participant decentralizing functional module 110 of the user node 30 may transfer the service smart contract transaction to the blockchain system 200 (S755) to pay the fee for the service provided by the service provider.

9. The blockchain front-end 210 may transfer the service smart contract transaction of the user node 30 to the blockchain node 220. The service smart contract module 222 of the blockchain node 220 may process the service smart contract transaction of the user node 30 (S760) and trigger the transaction completion event after processing the transaction (S765).

The blockchain front-end 210 may send a transaction completion response to the user node 30 when the transaction completion event is detected (S770). When the transaction is processed, the deposit of the user node 30 is stored and the initial installation fee for executing the service may be paid (S775).

10. The user node 30 may notify the provider node 40 of the payment completion of the deposit and the initial installation payment of the user (S780).

11. The provider node 40 may confirm the payment completion of the deposit and the initial installation payment by the user node through the blockchain system 200 (S785) and the provider node 40 may notify the user node 30 of the completion of the confirmation (S790).

Thereafter, the provider node 40 may store the subscriber information and the service profile in its node, and may play the role as the service provider subscribed to the account (or service use task) of the user node 30.

12. Likewise, the user node 30 may store the subscriber information and the service profile of the provider node 40 by creating the subscriber account. The user node 30 may subscribe to the event notification service for the participant registration status of the provider node through the blockchain front-end 210, so that information related to the subscriber account may be updated when the participant registration status of the provider node 40 changes.

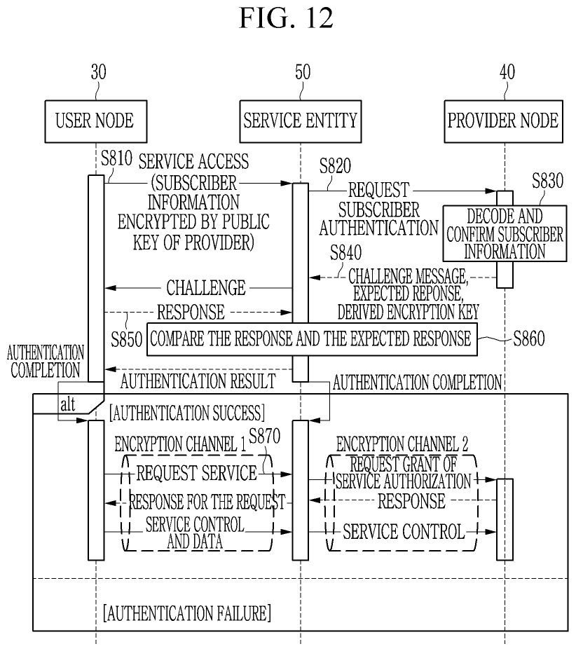

FIG. 12 is a flowchart illustrating mutual authentication, key agreement, and an authorization procedure occurred to provide and use a service according to an embodiment.

In order for a user to use the service of the service provider, the processes of mutual authentication, key agreement, and authorization needs to be completed. The mutual authentication in the decentralized network 10 is a process to confirm whether the other participant is registered in the decentralized network 10. The key agreement is the process of agreeing a master symmetric key to be shared between the user and the provider. The user and the provider may each independently derive the encryption key from the master symmetric key and encrypt the service channel and the message channel for the service by using the derived encryption key. The personal information between the users and the providers is protected through the encryption, and only authorized users can use the service. The provider may set the service authority to the service entity so that only a specific user can access the service. The service entity may execute service use authorization by encrypting the service channel so that only authorized users can access the service. In the decentralized network 10, the authentication process is different from other systems, and the processes of the key agreement and the authorization needs to be changed accordingly.

The mutual authentication, the key agreement, and the authorization according to the embodiment may be classified into a case where the user subscribes to an account (or work area) of the other participant and does not subscribe. FIG. 12 represents the processes of the mutual authentication, the key agreement, and the authorization when one participant has an account at the other participant node.

1. Referring to FIG. 12, the user node 30 may access the service entity 50 in the mutual authentication process and transmit the subscriber information encrypted with the public key of the provider node 40 to the service entity 50 (S810).

2. The service entity 50 may execute the authentication process for the user node 30 by transferring the encrypted subscriber information to the provider node 40 (S820).

3. The provider node 40 may perform the authentication of the user node 30 by decoding encrypted subscriber information (S830), and transfer a challenge message for authenticating the user node 30 as the subscriber and an expected response corresponding to the challenge message to the service entity 50 (S840). The provider node 40 may transfer the encryption key derived from the master symmetric key to the service entity 50 along with the challenge message and the expected response corresponding to the challenge message.

4. The user node 30 receiving the challenge message from the provider node 40 through the service entity 50 may transmit a response message for the challenge message to the service entity 50 (S850). The user node 30 may generate the response message for the challenge message from the user subscription information shared by the provider node 40 and the user node 30.

The response message for the challenge message may be predetermined between the user node 30 and the provider node 40 at the time of the subscription and may include mutual authentication means promised to each other. For example, a password may be the response message. Therefore, the response message for the challenge message may be pre-stored by the user node 30.

5. The service entity 50 may authenticate the user node 30 by comparing the response message of the user node 30 with the expected response of the provider node 40 (S860).

6. When the mutual authentication is successful, the user node 30 may request the service from the service entity 50 by configuring necessary encryption channels based on the encryption key derived from its master symmetric key (S870). The service entity 50 may decrypt the service requested by the user node 30 by the derived encryption key provided by the provider node and execute the service.

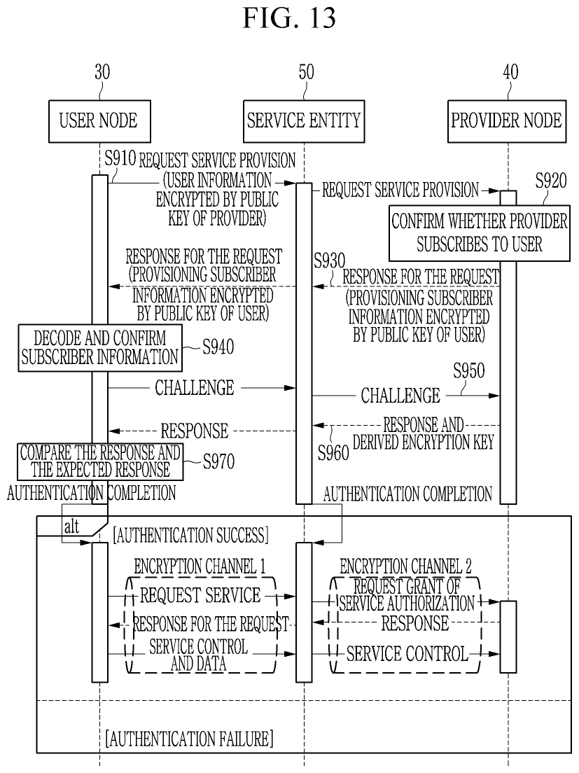

FIG. 13 is a flowchart illustrating mutual authentication, key agreement, and an authorization method of the participant decentralizing functional module according to another embodiment.

FIG. 13 may represent processes of the mutual authentication, the key agreement, and the authorization when the provider has its account at the user node.

1. Referring to FIG. 13, the user node 30 may access the service entity 50 and transmit a service request message including user information encrypted with the provider public key to the service entity 50 (S910).

2. The provider node 40 may decrypt the user information of the user node 30 received through the service entity 50 and may confirm whether the provider node 40 has its account at the user node 30 based on the decrypted user information (S920).

3. When the provider node 40 has its account at the user node 30, in response to the service request message, the provider node 40 may send a request response message including subscriber information encrypted with the public key of the user node 30 through the service entity 50 to the user node 30 (S930).

Upon receiving the request response message including the encrypted subscriber information through the service entity 50, the user node 30 may decrypt the subscriber information to confirm that the provider node 40 has its account (S940) and transmit the challenge message for authentication of the provider node 40 through the service entity 50 to the provider node 40 (S950).

4. The provider node 40 may transmit a response message for the challenge message received through the service entity 50 and an encryption key derived from the master symmetric key to the service entity 50 (S960).

5. The service entity 50 may transfer the response message of the provider node 40 for the challenge message to the user node 30 and the user node 30 may complete the subscriber authentication process by comparing the response message with the expected response (S970).

6. When the mutual authentication is successful as above, the user node 30 and service entity 50 may generate an encryption key, respectively, request a service using the generated encryption key, and use the requested service.

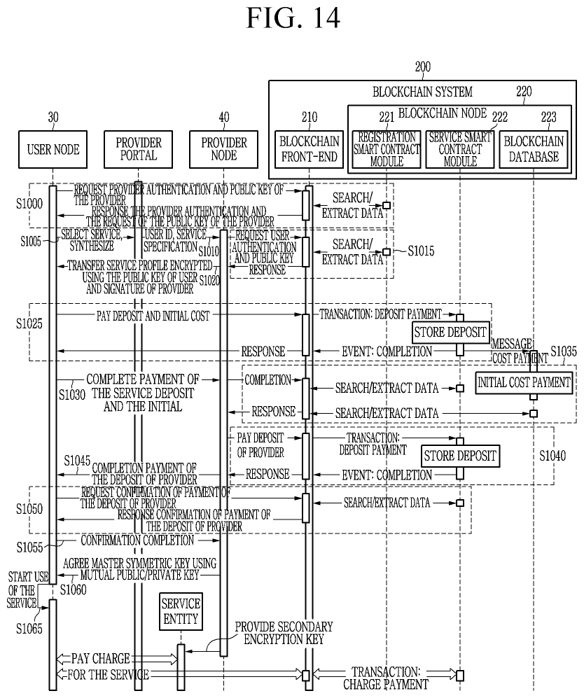

FIG. 14 is a flowchart illustrating mutual authentication, key agreement, and an authorization method of the participant decentralizing functional module according to another embodiment.

When the user does not have its account at the provider node in advance, the user may execute the mutual authentication with the service provider, make the deposit required to use the service, pay the service installation fee, agree on the encryption key, and get the authorization to use the service before the service is finally provided to the user. FIG. 14 describes procedure of the mutual authentication, the key agreement, and the authorization when there is no prior subscription according to another embodiment.

1. Referring to FIG. 14, the user node 30 may access the blockchain system 200 to authenticate the provider node 40 and obtain the public key of the provider node 40 (S1000).

2. The user node 30 may select a service through the provider portal of the provider node 40 or may compose a service (S1005).

3. The provider node 40 may receive the service selected by the user node 30 and the identifier of the user node 30 from the provider portal (S1010). Then, the provider node 40 may authenticate the user node 30 through the blockchain system 200 based on the identifier of the user node 30 and obtain the public key of the user node 30 (S1015). When the user node 30 is successfully authenticated through the blockchain system 200, the provider node 40 may transfer the service profile encrypted with the public key of the user node 30 to the user node 30 along with the signature of the provider node 40 (S1020).

4. The user node 30 may make a deposit required in advance to use the service and pay the initial installation fee through the service smart contract module 222 of the blockchain system 200 (S1025).

5. After that, the user node 30 may inform the provider node 40 that the deposit and the initial payment have been completed (S1030).

6. The provider node 40 may confirm the deposit and the initial payment of the user node 30 (S1035) and may make the deposit of the provider node 40 through the service smart contract module 222 in the blockchain system 200 (S1040). The provider node 40 may inform the user node 30 that the deposit setting by the provider has been completed (S1045).

7. The user node 30 may confirm that the provider node 40 has made the deposit (S1050) and may notify the provider node 40 of completion of the confirmation (S1055).

8. The user node 30 and the provider node 40 may agree on a master symmetric key to be shared with each other by using the public key and the private key of each other (S1060).

9. After that, the user node 30 and the provider node 40 may encrypt the service channel and the service message channel, request a service, and use the service with the encryption key derived from the shared master symmetric key (S1065).

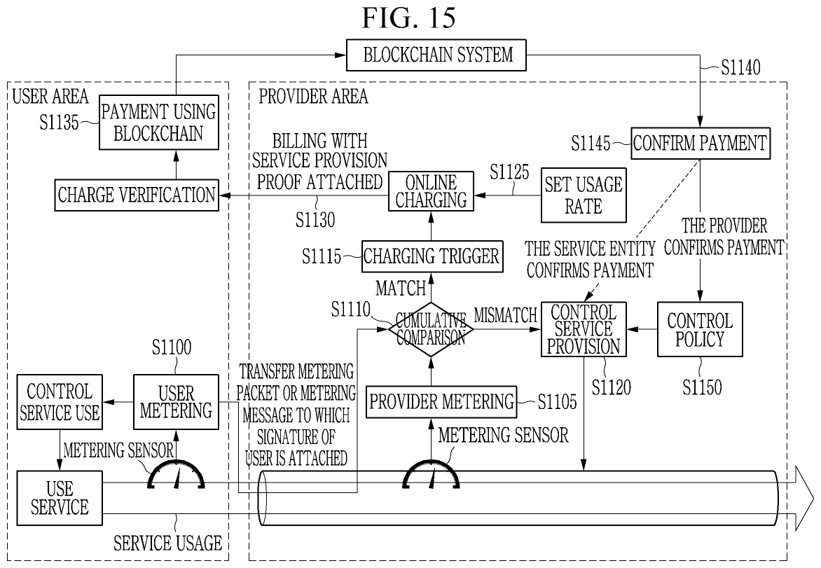

FIG. 15 is a diagram illustrating the procedure of charging, billing, and payment of a participant decentralizing functional module according to an embodiment.

In the decentralized network 10 where the mutual trust between users and providers is not formed, the charging, billing, and payment between participants should be conducted under the following conditions.
Each participant can trust the other party based on a deposit for a service. Therefore, if accumulated charge exceeds the deposit, the participant may request the payment of the charge.
The provider can present the proof of providing a service so that the user verifies it and the billing details.
The user can provide the proof of the service usage so that the provider can confirm it.

In the charging, billing, and payment function according to the embodiment, FIG. 15 represents processes of automatic charging, automatic billing, and automatic payment. Referring to FIG. 15, The automatic payment function of the user may include functions such as usage metering, fee verification, and blockchain payment. The automatic charging and automatic billing function of the provider may include functions such as usage metering, cumulative comparison of the usage, charging trigger, online charging, usage rate setting, payment confirmation, and the like. The service usage control, the use of services, and metering sensor in the user side may be functions included in the user node (or user terminal) and may be linked with the payment function. The policy control, service provision control, and metering sensor in the provider side may be included in the service entity of the provider and be linked with the charging function and the billing function.

1. Referring to FIG. 15, the user node 30 may measure service usage by using a metering sensor (user metering function) (S1100). The service usage may include the amount of data, the extent of the used resources, or the service time. The user node 30 may send the metering packets indicating the usage or metering messages to the service entity 50 with the user's signature attached to it. The user node 30 may transmit the metering packet or the metering message to the service entity 50 periodically or aperiodically. The transmission period of the metering packets or metering messages may be determined according to the service time, the amount of measured data, or the resource usage. The measured service usage may be used as information to control the service usage.

2. The provider node 40 may measure the service usage from the point of view of the provider by using the metering sensor (provider metering function) (S1105) and perform a cumulative comparison function by which a cumulative value of the difference between the service usage measured by the provider and the service usage received from the user and measured by the user is determined (S1110).

3. The provider node 40 may compare the service usage received from the user node 30 with the service usage measured by the provider metering function through the cumulative comparison function and determine whether the two usages match. When the service usage of the user node 30 matches the service usage of the provider node 40, the provider node 40 may transmit information about the service usage to a charging trigger function along with the signature of the user (S1115). When the service usage of the user node 30 and the service usage of the provider node 40 do not match, the provider node 40 may instruct the service control function included in the service entity 50 to restrict providing service (S1120).

4. The provider node 40 may accumulate the service usage through the charging trigger function and transmit information about the accumulated service usage to an online charging function along with the signature of the user when the accumulated service usage exceeds a predetermined triggering level (S1125).

5. The provider node 40 may calculate the charge according to the usage rate set by the usage rate determining function through the online charging function and may accumulate the charge. Subsequently, when the accumulated charge satisfies the predetermined billing condition, the provider node 40 may request the payment of the charge by attaching the proof of service provision to a charge verification function in the user area (S1130). The proof of service provision may be generated by using the signature of the user attached to the metering packet or the metering message.

6. The user node 30 may verify the service usage and the billing details through the charge verification function and issues the payment transaction to the blockchain system 200 when the billing is successfully verified (S1135).

7. The blockchain system 200 may generate payment details when the charge is paid by the charge payment transaction and notify the generated payment details to a payment confirmation function of the provider node 40 (S1140). The provider node 40 may subscribe to the payment details notification service of the blockchain system 200 at the start stage of the service.

8. The status of the service may be controlled according to the confirmation result of the payment confirmation function (S1145). When the payment is confirmed, the provider node 40 may continue to provide the service, and when the payment is not made (or not confirmed), the provider node 40 may restrict providing the service the contract. When the payment confirmation function is installed in the provider node 40, the service control function may be performed through the policy control function of the service entity 50 (S1150). When the payment confirmation function is directly installed in the service entity 50, the service control function may be performed directly by the payment confirmation function.

In the decentralized network 10, the online charging function may be installed either on the provider node 40 or on the service entity 50. The charging for the network services of existing communications provider may be made by a BSS independent of the service entity 50. As described above, in the decentralized network 10, the BSS of the network service may be included in the provider node 40. Therefore, when the network service is provided, the charging function may be installed in the provider node 40. However, for the case that the service is that to provide the network resource, it may be effective to install the charging function on the network resource itself. Accordingly, the charging, billing, and payment functions according to the embodiment may be presented for each of the following cases. The case that the online charging is installed on the provider node 40, and the case that the online charging is installed on the service entity 50.

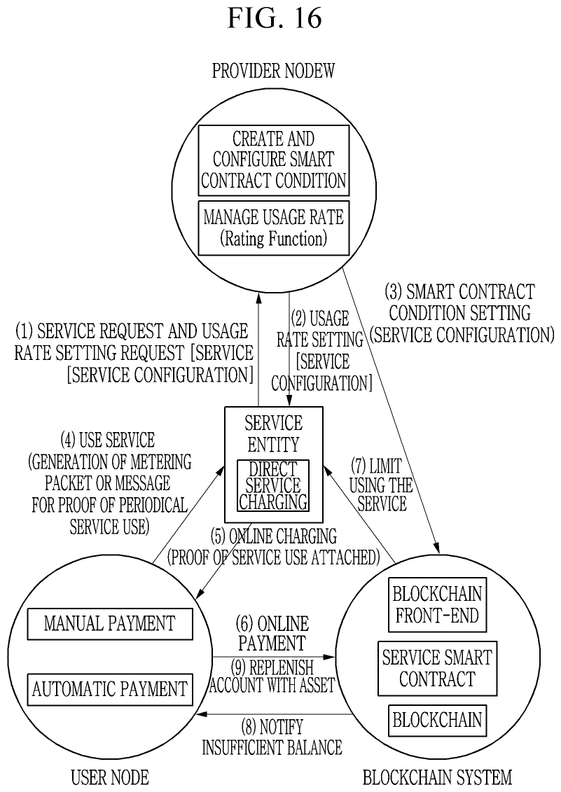

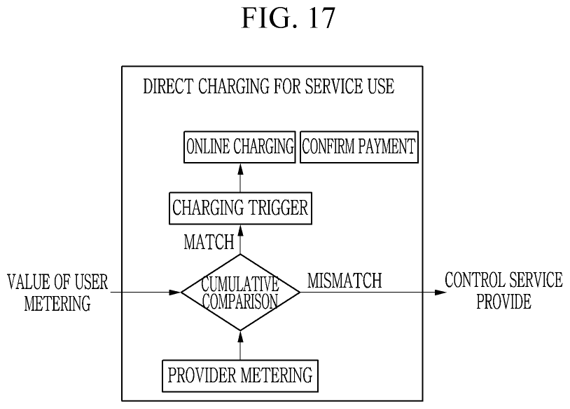

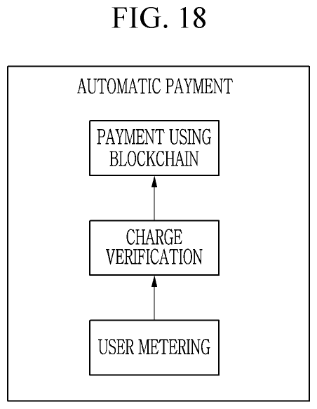

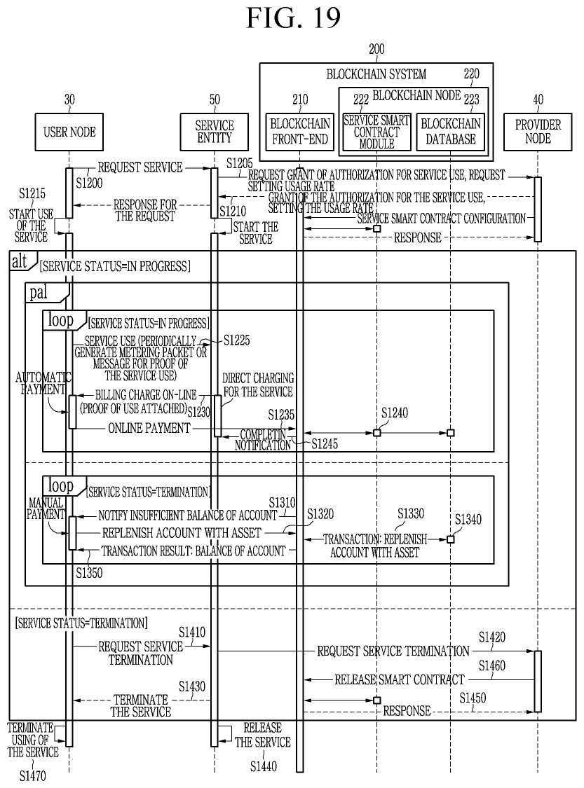

FIG. 16 is a diagram illustrating the charging, billing, and payment method of the participant decentralizing functional module according to an embodiment, FIG. 17 is a flowchart illustrating the direct charging function of the participant decentralizing functional module according to an embodiment, FIG. 18 is a flowchart illustrating the automatic payment function of the participant decentralizing functional module according to an embodiment, and FIG. 19 is a flowchart illustrating the procedure of charging, billing, and payment function of the participant decentralizing functional module according to another embodiment.

FIG. 16 shows the charging, billing, and payment functions in case of direct charging by the service entity 50. The user node 30 may perform an automatic payment function and a manual payment function. The provider node 40 may perform a usage rate management function and a smart contract condition creation and configuration function. The service entity 50 may perform a service direct charging function.

FIG. 17 shows a service direct charging function according to the embodiment. The service direct charging function may include provider metering, cumulative comparison, charging trigger, online charging, payment confirmation function, and the like. FIG. 18 shows an automatic payment function according to the embodiment. The automatic payment function may include functions such as user metering, charge verification, and blockchain payment.

Referring to FIG. 16 and FIG. 19, when the service entity 50 directly charges to the user node 30, the start stage of the service of the charging, billing, and payment functions is described below.

1. After completing the authentication, key agreement, and authorization process, the user node 30 may transmit a service request message to the service entity 50 through the encrypted channel (S1200).

2. The service entity 50 may transfer the service request message of the user node 30 to the provider node 40 and request the setting of the usage rate (S1205).

3. The provider node 40 may check the service profile for the user node 30 to determine whether to allow the service and send a response message to the service entity 50 based on the determination (S1210). When the service is allowed, the provider node 40 may transfer the usage rate to the service entity 50 and configure the service smart contract module 222.

4. The service entity 50 may transfer the response message to the user node 30. When the service is allowed, the service entity 50 may encrypt the service and the service message channel with an encryption key and initiate the service (S1215).

5. When the user node 30 receives the response message indicating the granting of the service, it may encrypt the service and the service message channel with the encryption key and use the service (S1220).

In the case of direct charging by the service entity 50, the charging, billing, and payment functions according to the service progress status are shown in FIG. 16 and FIG. 19.

1. The user node 30 may send the metering packets or the metering messages to the service entity 50 through the service channel or the service message channel along with the signature of the user by using the automatic payment function (S1225). The metering packets or the metering messages may be used to prove the service usage of the user node 30. When the metering packet or the metering message is periodically transmitted to the service entity 50, the period may be determined according to the service time or the service usage.

2. The service entity 50 may compare the metering packets or the metering messages received by the service direct charging function with the directly measured service usage. When the received metering packets or metering messages do not match with the measured usage, the service entity 50 may stop providing the service according to the service contract. When the charge for the service usage exceeds the predetermined value, the service entity 50 may send the bill to which the service usage certificate is attached to the user node 30 on-line (S1230).

3. For the automatic payment, the user node 30 may verify the billing details of the charge through the charge verification function by using the proof of service provision received from the provider node 40 and transmit the service smart contract transaction to pay the charge to the blockchain system 200 when the details of the charge are verified (S1235).

4. The blockchain front-end 210, the service smart contract module 222, and the blockchain database 223 of blockchain system 200 may process the transactions of the user node 30 (S1240).

5. When the transaction processing completion event is detected, the blockchain front-end 210 may notify the service entity 50 of the completion of the transaction processing (S1245). The provider node 40 may subscribe to the notification service of the blockchain front-end 210 so as to notify the service entity 50 of the user payment completion event at the start stage of the service.

6. The service entity 50 may request the payment through the service direct charging function and when there is no abnormality in the payment result, the service may continue. While the service is in progress, in the service entity 50, steps S1230 to S1245 may be repeated.

When the service entity 50 directly charges, the user account may be replenished as follows when the service of the charging, billing, and payment functions is in progress.

1. The blockchain front-end 210 of the blockchain system 200 may notify the user node 30 that the balance of the user's blockchain account is insufficient (S1310). The user node 30 may previously subscribe to an insufficient balance notification service of the blockchain front-end 210 and pre-set the event occurrence condition in advance.

2. The user node 30 may request the blockchain system 200 to refill the cryptocurrency assets of user's blockchain account through the manual payment function (S1320). Specifically, the manual payment function of the user node 30 may issue a transaction that refills the cryptocurrency assets to the account of the user node 30 and transmit the generated transaction to the blockchain front-end 210.

3. The blockchain front-end 210 may transfer the transaction to the blockchain node 210 (S1330).

4. Afterwards, the blockchain system 20 may process the transactions S1340.

5. The blockchain front-end 210 may detect the transaction processing event (S1350) and notify the refilled balance of user's account of to the manual payment function of the user node 30. The balance refill process may be repeated in the order of the steps S1310 through S1350 while the service is in progress.

The service termination of the charging, billing, and payment functions in the case of the direct charging by the service entity 50 is described below.

1. The user node 30 may request the service entity 50 to terminate the service (S1410).

2. The service entity 50 may transfer a service termination request to the provider node 40 (S1420), and after transmitting a response message for the service termination request to the user node 30 (S1430), the service entity 50 may release the service (S1440). When the service is inactive for a while (alternatively for a long time), the service entity 50 may determine that the service is terminated by itself without communication with the user node 30 and terminate the service. The service entity 50 may inform the provider node 40 of the service termination (S1450).

3. The provider node 40 may release predetermined clauses in the service smart contract module 214 according to the service (S1460).

4. The user node 30 may terminate the use of the service when the response message for the service termination request is received (S1470).

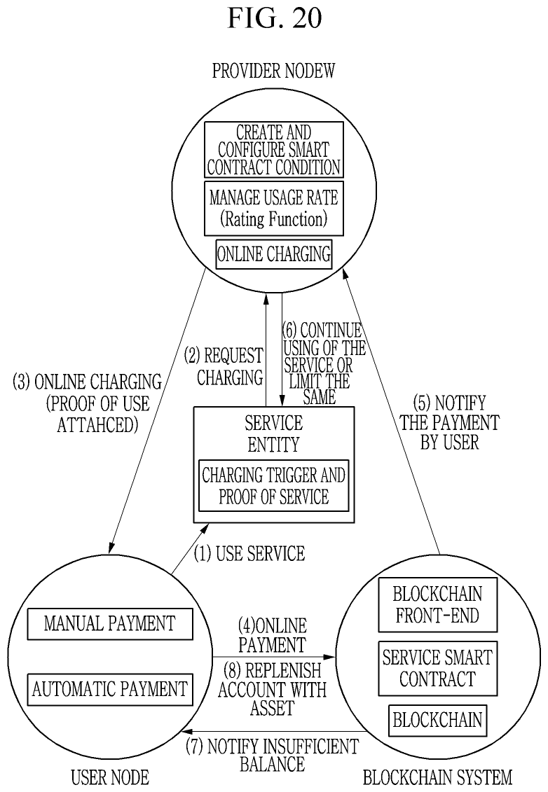

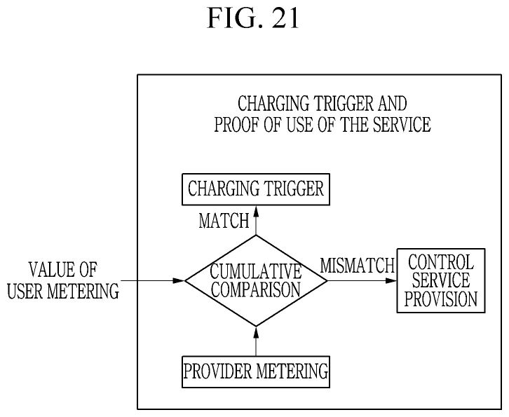

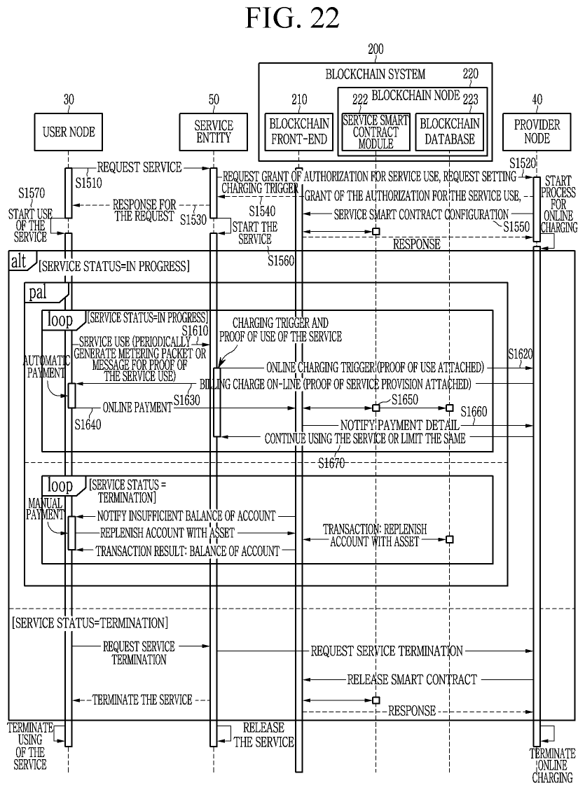

FIG. 20 is a diagram illustrating the charging, billing, and payment functions of the participant decentralizing functional module according to another embodiment, FIG. 21 is a flowchart illustrating a charging trigger and service proof function according to an embodiment, and FIG. 22 is a flowchart illustrating the procedure of the charging, billing, and payment of the participant decentralizing functional module according to another embodiment.

Referring to FIG. 20, the user node (or user terminal) 30 may include the automatic payment function and the manual payment function. The provider node 40 may include functions such as online charging, management of the usage rate, and creation and configuration of the smart contract conditions. The service entity 50 may include charging trigger and service proof.

Referring to FIG. 21, the charging trigger and the service proof process according to the embodiment may include functions such as the provider metering, the cumulative comparison, and the charging trigger.

In the following, the start stage of the service of the charging, billing, and payment functions when the provider node 40 charges is described referring to FIG. 20 and FIG. 22.

1. After the authentication, key agreement, and authorization, the user node 30 may request a service to the service entity 50 through an encrypted channel (S1510).

2. The service entity 50 may transmit the service request of the user node 30 to the provider node 40 and request charging trigger configuration S1520.

3. The provider node 40 may determine whether to allow the service by checking the service profile for the user node 30. When the service is permitted, the provider node 40 may transfer a response message for the service request transmitted from the service entity 50 to the user node 30 via the service entity 50 (S1530) and send charging trigger configuration to the service entity 50 (S1540). The provider node 40 may configure the service smart contract module 222 of the blockchain system 200 (S1550). When the configuration of the service smart contract module 222 is completed, the provider node 40 may start online charging for the user node 30.

4. The service entity 50 may transfer the response message for the service request to the user node 30, encrypt the service and the service message channel with an encryption key when the service is allowed, and start providing the service (S1560).

5. When the response message including the grant of the service is received, the user node 30 may encrypt the service and the service message channel with the encryption key and start to use the service (S1570).

When the provider node 40 executes the online charging function, the procedures of charging, billing, and payment for the service in process are described below, referring to FIG. 20 and FIG. 22.

1. The user node 30 may (periodically) transmit the metering packets or the metering messages proving the service usage to the service entity 50 through the service channel or the service message channel along with the signature of the user by using the automatic payment function (S1610). The transmission period of the metering packets or the metering messages may be determined in advance according to the service time or the service usage.

2. The charging trigger and service proof function of the service entity 50 may receive the metering packets or the metering messages from the user node 30 and compare the received metering packet or metering message with the service usage measured by the service entity 50. When the received metering packet or metering message differs from the service usage measured by the service entity 50, the service entity 50 may stop providing the service to the user node 30 according to the service contract. When the received metering packet or metering message matches the service usage measured by the service entity 50, the service entity 50 may accumulate the service usage. After the accumulated service usage satisfies the predetermined charging trigger level, the service entity 50 may send a charging request to the provider node 40 together with the usage and the signature of the user (S1620).

3. The provider node 40 may calculate and accumulate the charge for the usage according to the predetermined usage rate by the usage rate management function through the online charging function. When the accumulated charges satisfy the billing condition, the charge to which the service provision certificate is attached is requested to the user node 30 (S1630).

4. In the automatic payment function, the user node 30 may verify the details of the charge through the charge verification function by using a service provision proof. When the details of the charge are verified, the user node 30 may pay the charge by sending the service smart contract transaction to the blockchain system 200 (S1640).

5. The blockchain front-end 210, the service smart contract module 222, and the blockchain database 223 of the blockchain system 200 may process the service payment transaction issued by the user node 30 (S1650).

6. The blockchain front-end 210, when the transaction processing is completed, may notify the result of the transaction processing to the provider node 40 (S1660). The provider node 40 may previously subscribe to the user payment completion event of the blockchain front-end 210 at the start stage of the service.

7. The provider node 40 may confirm the payment (S1670) and execute step S1620 when there is no abnormality in the payment details. While the service is in progress, steps S1620 to S1670 may be sequentially repeated.

When the provider node 40 providing the service performs the online charging, procedures for the refill of the user account and the service termination depicted in FIG. 16 and FIG. 19 in case that the charging, billing, and payment functions are in progress may be added in the processes of FIG. 20 and FIG. 22. In order to terminate the service, an online charging termination step may be further added.

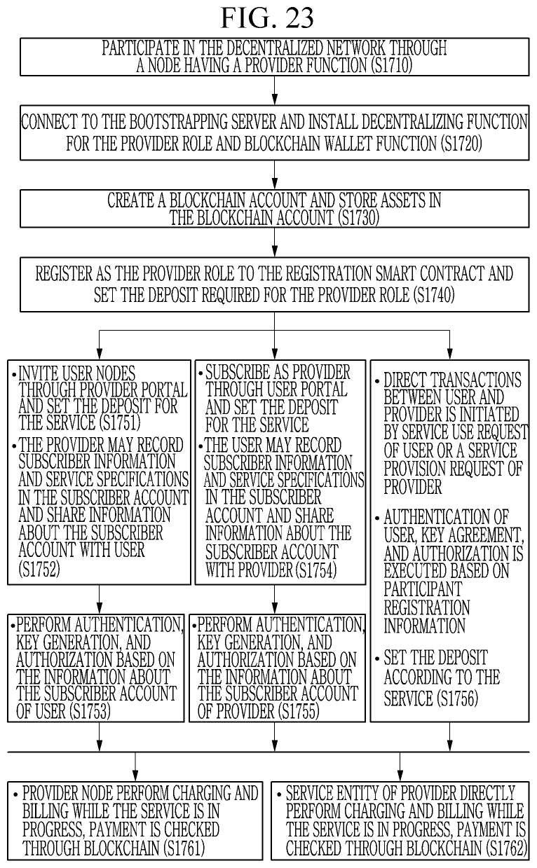

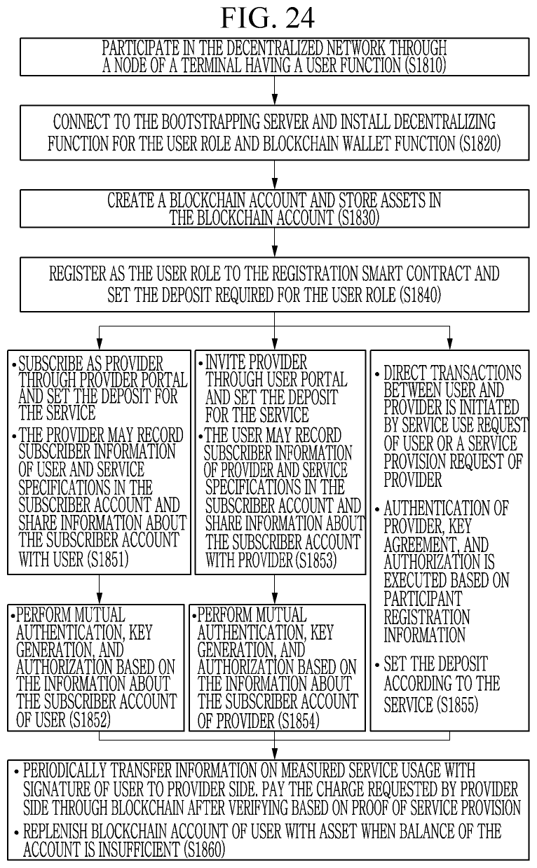

Referring to FIG. 23 and FIG. 24, processes for the participant node of the decentralized network according to an embodiment is described below.

FIG. 23 is a flowchart illustrating the operation of the provider node of the decentralized network according to the embodiment.

1. Referring to FIG. 23, the provider may participate in the decentralized network 10 through a node having a provider function (S1710).

2. The provider node 40 may connect to the decentralizing functional unit 100 and install the participant decentralizing functional module 110 for the provider role such as the blockchain wallet function 111 by using the bootstrapping server 120 (S1720).

3. The provider node 40 may create a blockchain account and store cryptocurrency assets to be consumed in the decentralized network 10 for transaction and deposit in the blockchain account (S1730).

4. The provider node 40 may register in the blockchain system 200 as the provider role (e.g., network resource provider or network service provider) through the registration smart contract module 221 of the blockchain system 200 and make a deposit required for the provider role (S1740). The participants registered in the decentralized network 10 may be recognized by a participant identifier, which is a unique value throughout the system. The registration smart contract module 221 may create a participant registration account and store in the participant registration account and update the information including the participant identifier, the participant public key, a blockchain account identifier of one or more participants, the participant role, subscription information of the participant, an access address of the participant, a deposit of the participant.

5. Then, the provider node 40 may execute one of the following three actions.

5.1 The provider node 40 may announce services that can be provided through the provider portal of the provider node 40 and may invite user nodes 30 as subscribers. Then, the provider node 40 may create a subscriber account for the invited user node 30, record subscriber information and service profiles, and set deposit for the user according to the service (S1751). Information about the subscriber account may be shared by the provider node 40 and the user node 30 (S1752). When user node 30 connects to the service entity 50, the provider node 40 may authenticate the user node 30 based on the information in the subscriber account of the user node 30. When the user node 30 is successfully authenticated, the provider node 40 may generate an encryption key from the master symmetric key shared with the user node 30, encrypt the channel required for the service with the generated encryption key, and authorize the user node 30 to use the service (S1753).

5.2 The provider node 40 may subscribe to the user node 30 as the provider node 40 through the user portal of the user node 30. The provider node 40 may make the deposit required for service provision and may receive and store the information about the subscriber account created by the user node 30 from the user node 30 (S1754). When the user node 30 accesses to the service entity 50, the provider node 40 may authenticate the user node 30 based on the information about the subscriber account. When the authentication for the user node 30 is successful, the provider node 40 may generate an encryption key from the master symmetric key shared with the user node 30, encrypt the channel required for the service execution by using the generated encryption key, and authorize the user node 30 to use the service (S1755).

5.3 A transaction for the service use and the provision may be initiated between the user node 30 and the provider node 40 by a service use request of the user node 30 or a service provision request of the provider node 40. The provider node 40 may authenticate the user node 30 through the participant registration information and perform agreement on the master symmetric key with the user node 30. Then, the provider node 40 may generate an encryption key from the agreed master symmetric key, use the generated encryption key for encryption of a channel required during service use, and authorize the user node 30 to use the service (S1756).

6. When services are provided to the user node 30 to which the authentication, key agreement, and authorization is completed through the processes described above, the charging, billing, and payment confirmation may vary depending on the charging entity.

6.1 The provider node 40 may perform online charging and billing for the charges to the user node 30 (S1761). The provider node 40 may provide the user node 30 with the proof of service provision. The provider node 40 may confirm the payment through the blockchain system 200.

6.2 The service entity 50 of the provider node 40 may directly perform the online charging and billing for the charges (S1762). The service entity 50 may send the bill for the service usage along with the proof of service provision to the user node 30. The service entity 50 may check the payment of the user node 30 through the blockchain system 200.

FIG. 24 is a flowchart illustrating the process of the user node in the decentralized network according to an embodiment.

1. Users may participate in the decentralized network 10 through a node or a terminal of a user function (S1810).

2. The user node 30 may access the bootstrapping server 120 of the decentralizing functional unit 100 and install the participant decentralizing functional module 110 of the user role, such as the blockchain wallet function 111 (S1820).

3. The user node 30 may create a blockchain account through the blockchain wallet function of the participant decentralizing functional module 111 and store cryptocurrency assets to be used in the decentralized network 10 for transactions and deposit in its blockchain account (S1830).

4. The user node 30 may register in the blockchain system 200 as the user role (e.g., user of network resource, end user, application service provider, etc.) through the registration smart contract module 221 of the blockchain system 200 and make a deposit required for the user role (S1840). The user node 30 may be recognized with a unique participant identifier.

5. The user node 30 may execute one of the following two actions.

5.1 The user node 30 may subscribe to the provider node 40 as the user node 30 through the provider portal of the provider node 40 (S1851). The user node 30 may make a deposit required for the use of the service and may receive and keep information about a subscriber account of the provider node 40 created by the provider node 40 from the provider node 40 (S1852).

5.2 The user node 30 may solicit service requirements to be used in the portal of the user node 30 and may invite provider nodes as the subscriber (S1853). The user node 30 may create a subscriber account for the provider node 40, record subscriber information and service profiles, and set a deposit according to the service (S1854). Information about the subscriber account of the provider node 40 may be shared by the user node 30 and the provider node 40.

5.3 Meanwhile, a transaction for service use and provision between the user node 30 and the provider node 40 may be initiated by a service use request from the user node 30 or a service provision notification from the provider node 40 (S1855). After the user node 30 authenticates the provider node 40 through the participant registration information, the user node 30 may agree a master symmetric key with the provider node 40. Then, the user node 30 may generate an encryption key from the agreed master symmetric key, encrypt the channel required during service use by using the generated encryption key, and get the authorization to use the service from the provider node 40.

6. While the service is in progress, the user node 30 may (periodically) send metering packets or metering messages to check the service usage to the provider node 40 along with a signature of the user. The user node 30 may verify the charges determined based on the metering packet or the metering message by using service provision proof and may pay the verified charge through the blockchain system 200 (S1860). The user node 30 may refill the balance of user's blockchain account to continue using the service.

Without changing the existing network system, by adding a decentralized function using a blockchain system, the functions related to a decentralization and the network function can be easily separated. Therefore, regardless of a user terminal, a base station, a core network, and operation management that satisfy both the current and future standards, a decentralized network can be realized by adding a software with the decentralized function to the user terminal and decentralized function charging.

In addition, since network resources positioned in each of the private domain, public domain, and communication service provider domain can be integrated and reconfigured, a network environment that is cost-efficient, environmentally-friendly, and capable of efficient evolution can be built without redundant investment. In addition, charging and payment between transaction parties without mutual trust can be implemented in a decentralized manner. In addition, an existing terminal equipped with a decentralized function-related app is joined a mobile communication system such as a 5G system by a participant identifier of the decentralized network, so that a decentralized mobile communication service can be realized.

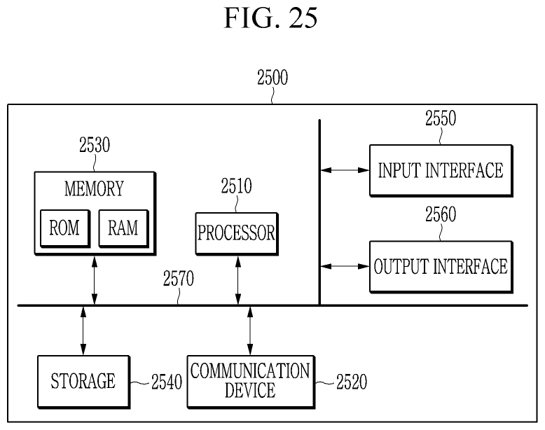

FIG. 25 is a block diagram illustrating a blockchain system according to another embodiment.

The blockchain system according to another embodiment may be implemented as a computer system, for example, a computer-readable medium. Referring to FIG. 25, the computer system 2500 may include at least one of a processor 2510, a memory 25250, an input interface device 2550, an output interface device 2560, and a storage device 2540 communicating through a bus 2570. The computer system 2500 may also include a communication device 2520 coupled to the network. The processor 2510 may be a central processing unit (CPU) or a semiconductor device that executes instructions stored in the memory 2530 or the storage device 2540. The memory 2530 and the storage device 2540 may include various forms of volatile or nonvolatile storage media. For example, the memory may include a read only memory (ROM) or a random-access memory (RAM).

In the embodiment of the present disclosure, the memory may be located inside or outside the processor, and the memory may be coupled to the processor through various means already known. The memory is a volatile or nonvolatile storage medium of various types, for example, the memory may include a read-only memory (ROM) or a random-access memory (RAM).

Accordingly, the embodiment may be implemented as a method implemented in the computer, or as a non-transitory computer-readable medium in which computer executable instructions are stored. In an embodiment, when executed by a processor, the computer-readable instruction may perform the method according to at least one aspect of the present disclosure.

The communication device 2520 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system 08 and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

While this disclosure has been described in connection with what is presently considered to be practical example embodiments, it is to be understood that this disclosure is not limited to the disclosed embodiments. On the contrary, it is intended to cover various modifications and equivalent arrangements included within the spirit and scope of the appended claims.

What is claimed is:

1. An apparatus for using a service through a blockchain system, the apparatus comprising:
a processor, a memory, and a communication device, wherein the processor executes a program stored in the memory to perform:
confirming, through the blockchain system by using the communication device, that a provider node providing the service is a participant in a decentralized network; and
using the service provided by the provider node when it is confirmed through the blockchain system by using the communication device that the provider node is the participant of the decentralized network.

2. The apparatus of claim 1, wherein the processor executes the program to further perform paying a charge for the use of the service through the blockchain system by using the communication device after the using of the service.

3. The apparatus of claim 2, wherein when the processor performs the paying of the charge for the use of the service through the blockchain system, the processor performs:
receiving billing details of the charge and proof of service provision from the provider node by using the communication device;
verifying the billing details by using the proof of service provision; and
transmitting a service smart contract transaction to pay the charge through the blockchain system by using the communication device when the billing details are verified.

4. The apparatus of claim 1, wherein the processor executes the program to further perform:
connecting with a bootstrapping server of the decentralized network by using the communication device and installing a participant decentralizing functional module under a control of the bootstrapping server; and
generating a blockchain account by using the participant decentralizing functional module and registering a user node coupled to the apparatus in the blockchain system through a registration smart contract module of the blockchain system.

5. The apparatus of claim 1, wherein when the service is a network service provided using a network resource, the user node is a terminal and the provider node is a network service provider.

6. The apparatus of claim 1, wherein when the service is a service that provides a network resource, the user node is a network service provider that provides the service using the network resource, and the provider node is a resource provider.

7. The apparatus of claim 1, wherein the processor executes the program to further perform:
selecting a service that the provider node is capable of providing within a provider portal of the provider node; and
generating a subscriber account for the user node in the provider node and setting a deposit for the service.

8. The apparatus of claim 1, wherein:
the processor executes the program to further perform receiving an identifier of the provider node and a service specification of the service selected by the provider node from the provider node through a user portal by using the communication device, and
when the processor performs the confirming, through the blockchain system by using the communication device, that a provider node providing the service is a participant in the decentralized network, the processor performs confirming, by using the identifier of the provider node, that the provider node is a registered participant in the decentralized network.

9. The apparatus of claim 1, wherein before the processor performs the using the service provided by the provider node, the processor executes the program to further perform:
agreeing on a master symmetric key with the provider node; and
generating an encryption key from the master symmetric key and encrypting a channel required for the service using generated encryption key.

10. A method for using a service through a blockchain system, the method comprising:
confirming, through the blockchain system, that a provider node providing the service is a participant in a decentralized network; and
using the service provided by the provider node when it is confirmed through the blockchain system that the provider node is the participant in the decentralized network.

11. The method of claim 10, further comprising: after the using of the service, paying a charge for the use of the service through the blockchain system.

12. The method of claim 11, wherein the paying of the charge for the use of the service through the blockchain system includes:
receiving billing details of the charge and proof of service provision from the provider node;
verifying the billing details by using the proof of service provision; and
transmitting a service smart contract transaction to pay the charge through the blockchain system when the billing details are verified.

13. The method of claim 10, further comprising:
connecting with a bootstrapping server of the decentralized network and installing a participant decentralizing functional module under a control of the bootstrapping server; and
generating a blockchain account by using the participant decentralizing functional module and registering a user node in the blockchain system through a registration smart contract module of the blockchain system.

14. The method of claim 10, wherein when the service is a network service provided using network resources, the user node is a terminal and the provider node is a network service provider.

15. The method of claim 10, wherein when the service is a service that provides a network resource, the user node is a network service provider that provides the service using the network resource, and the provider node is a resource provider.

16. The method of claim 10, further comprising:
selecting a service that the provider node is capable of providing within a provider portal of the provider node; and
generating a subscriber account for the user node in the provider node and setting a deposit for the service.

17. The method of claim 10, further comprising receiving an identifier of the provider node and a service specification of the service selected by the provider node from the provider node through a user portal,
wherein the confirming, through the blockchain system, that a provider node providing the service is a participant in the decentralized network includes confirming, by using the identifier of the provider node, that the provider node is a registered participant in the decentralized network.

18. The method of claim 10, further comprising:
before the using of the service provided by the provider node,
agreeing on a master symmetric key with the provider node; and
generating an encryption key from the master symmetric key and encrypting a channel required for the service using generated encryption key.

19. A blockchain system comprising:
a registration smart contract module configured to register a participant in the decentralized network by processing a registration-related transaction generated by the participant;
a service smart contract module configured to process a transaction generated when the participant uses the decentralized network to provide a service or the participant uses the decentralized network to use the service; and
a blockchain database configured to process cryptocurrency assets used when the participant uses the service or provides the service,
wherein the participant is one of a user node that uses the service, a provider node that provides the service or provides the resource for the service.
